(19) United States
(12) Patent Application Publication
(10) Pub. No.: US 2012/0259965 A1
(43) Pub. Date: Oct. 11, 2012

(54) APPARATUS, METHOD OF MANAGING A SYSTEM, AND COMPUTER PROGRAM PRODUCT

(75) Inventors: Masanao Tsuzuki, Nagoya-shi (JP); Goki Ichikawa, Nagoya-shi (JP)

(73) Assignee: Buffalo Inc., Nagoya-shi (JP)

(21) Appl. No.: 13/441,463

(22) Filed: Apr. 6, 2012

(30) Foreign Application Priority Data
Apr. 8, 2011 (JP) 2011-85867

(51) Int. Cl. G06F 15/173

(52) U.S. Cl. 709/223

(57) ABSTRACT

A apparatus manages a system including a gateway device, a first device and a second device. The apparatus obtains configuration information and connected device identification information with respect to at least one device, obtains software from a server, and applies the software to the device.

### CROSS-REFERENCE TO RELATED APPLICATION

This application claims the benefit of priority under 35 U.S.C. §119 to Japanese Patent Application No. 2011-85867 filed on Apr. 8, 2011, which is hereby incorporated by reference in its entirety and for all purposes.

### BACKGROUND

1. Technical Field

This disclosure relates to managing a system including a plurality of devices connected by various connection interfaces.

2. Related Art

With recent advancement of various interfaces for connection between devices, various devices are connected in the home or small business. For example, a personal computer and a router are connected by wireless connection; a TV tuner and a router are connected by a USB (Universal Serial Bus) cable or an HDMI (High-Definition Multimedia Interface) cable; and a printer and a NAS (Network Attached Storage) are connected by a USB cable and the NAS and a router are further connected by a LAN (Local Area Network) cable.

A management system is introduced for a network system including connections of a number of devices, in order to check the connection configuration of the respective devices and gather information required for locating a failure (e.g., error log). For example, an SNMP (Simple Network Management Protocol) management system has been proposed as the management device for managing a network system where devices are connected through LAN.

The SNMP management system is generally designed for a large-scaled network system and requires the high initial cost and advanced expertise for use, thus being not adequate for managing various devices, for example, in the home.

Additionally, the SNMP management system is designed for devices connected by network interfaces, for example, router and server, as the management object and cannot manage devices connected by bus interfaces (for example, TV tuner and TV receiver interconnected by HDMI). Especially in the home or small business, an individual member (family member or employee) is likely to connect a device connected by a bus interface to another device without the permission of the other members, which increases in number of devices that are not manageable by the management system. Introducing a dedicated management system for each connection interface type disadvantageously increases the initial cost of the whole management system. Additionally, the user is required to operate different operation terminals of the respective management systems, in order to understand the connection configuration of all the devices. Understanding the connection configuration takes time and labor, and the advanced expertise is required for the respective management systems.

Updating the software (e.g., firmware and applications) applied to the respective devices requires a high level of expertise and rather troublesome operations to check the current version of the applied software and download the software of the newer version. It is thus not easy to update the software applied to the respective devices in the home or small business. In some cases, there is a limitation in update sequence in the course of updating a plurality of software applied to the respective devices. For example, the firmware applied to the wireless client may be required to be updated prior to the firmware applied to the wireless LAN access point. In another example, in the course of updating the firmware in one identical device, update to the prior version may be required prior to update to the newest version. It is rather hard to update a plurality of software to the newer versions according to the specified update sequence in the home or small business.

### SUMMARY

Consequently, there is a need to facilitate updating the software applied to the respective devices, as well as management of a plurality of devices connected by means of various interfaces.

According to one exemplary embodiment, an apparatus is configured to manage a system including a gateway device, a first device connected with the gateway device and a second device that is connected with the first device and has a greater number of devices intervening before the gateway device than the first device, the apparatus includes:

a configuration information acquirer that acquires configuration information and connected device identification information from a first target device that is at least one of the gateway device, the first device and the second device, wherein the configuration information includes information indicating a type of a connection interface included in the first target device and device identification information identifying the first target device, and the connected device identification information identifies a device connected to the first target device;

a software acquirer that acquires software to be applied to at least the first target device from a server based on the obtained configuration information, wherein the server is connected with the apparatus via a network; and

a software application controller that applies the acquired software to the first target device.

According to another embodiment, a method of managing a system by using an apparatus having a display, wherein the system comprises a gateway device, a first device connected with the gateway device and a second device that is connected with the first device and has a greater number of devices intervening before the gateway device than the first device is directed. The method includes: acquiring, by the apparatus, configuration information and connected device identification information from a first target device that is at least one of the gateway device, the first device and the second device, wherein the configuration information includes information indicating a type of a connection interface included in the first target device and device identification information identifying the first target device, and the connected device identification information identifies a device connected to the first target device;

acquiring, by the apparatus from a server, software to be applied to at least the first target device based on the obtained configuration information, wherein the server is connected with the apparatus via a network; and

applying the acquired software to the first target device.

According to another embodiment, a non-transitory computer-readable medium includes computer program instructions, which when executed by an apparatus, causes the apparatus to perform a method of managing a system that includes a gateway device, a first device connected with the gateway device and a second device that is connected with the first device and has a greater number of devices intervening before the gateway device than the first device is directed. The method includes:

acquiring, by the apparatus, configuration information and connected device identification information from a first target device that is at least one of the gateway device, the first device and the second device, wherein the configuration information includes information indicating a type of a connection interface included in the first target device and device identification information identifying the first target device, and the connected device identification information identifies a device connected to the first target device;

acquiring, by the apparatus from a server, software to be applied to at least the first target device based on the obtained configuration information, wherein the server is connected with the apparatus via a network; and

applying the acquired software to the first target device.

### BRIEF DESCRIPTION OF THE DRAWINGS

FIG. 1 illustrates the general configuration of a system, to which a management device according to one embodiment of the disclosure is applied;

FIG. 2 is a block diagram illustrating the detailed structure of the router shown in FIG. 1;

FIG. 3 illustrates the general structure of the management PC shown in FIG. 1;

FIG. 4 illustrates the general structure of the device server shown in FIG. 1;

FIG. 5 illustrates the general structure of the software management server shown in FIG. 1;

FIG. 6 shows the settings of the applicable condition table shown in FIG. 5;

FIG. 7 is a sequence diagram showing a procedure of configuration information gathering process according to the first embodiment;

FIG. 8 illustrates an example of the lower-level device list created at step S215;

FIG. 9 schematically illustrates one example of configuration information gathering according to the first embodiment;

FIG. 10 illustrates an exemplary system configuration map displayed on the display as the result of the map generation process;

FIG. 11 is a flowchart showing the detailed procedure of step S120 shown in FIG. 7;

FIG. 12 illustrates the system configuration maps after the processing of step S910 and the processing of step S915 shown in FIG. 11;

FIG. 13 illustrates the system configuration maps after the processing of step S915 and the processing of step S920 shown in FIG. 11;

FIG. 14 illustrates the system configuration maps after the processing of step S920 and the processing of step S925 sown in FIG. 11;

FIG. 15 is a flowchart showing the procedure of software update process performed in the system;

FIG. 16 is a sequence diagram schematically showing an example of applying the newer version of the software;

FIG. 17 schematically illustrates the structure of a management PC according to a second embodiment;

FIG. 18 is a sequence diagram showing a procedure of configuration information gathering process according to the second embodiment;

FIG. 19 is a flowchart showing the detailed procedure of the map generation process (step S120) according to a third embodiment;

FIG. 20 illustrates one example of the system configuration map when the processing of step S945 is performed;

FIG. 21 illustrates a system configuration map displayed on the display according to a fourth embodiment;

FIG. 22 illustrates a system configuration map displayed on the display according to a fifth embodiment;

FIG. 23 illustrates an exemplary system configuration map displayed on the display of the management PC according to one modification;

FIG. 24 schematically illustrates one example of the system connection configuration according to one modification;

FIG. 25 schematically illustrates another example of the system connection configuration according to another modification;

FIG. 26 schematically illustrates another example of the system connection configuration according to another modification;

FIG. 27 schematically illustrates another example of the system connection configuration according to another modification; and

FIG. 28 illustrates one example of system configuration map displayed on the display of the management PC according to one modification.

### DETAILED DESCRIPTION

### A. First Embodiment

A1. General Configuration

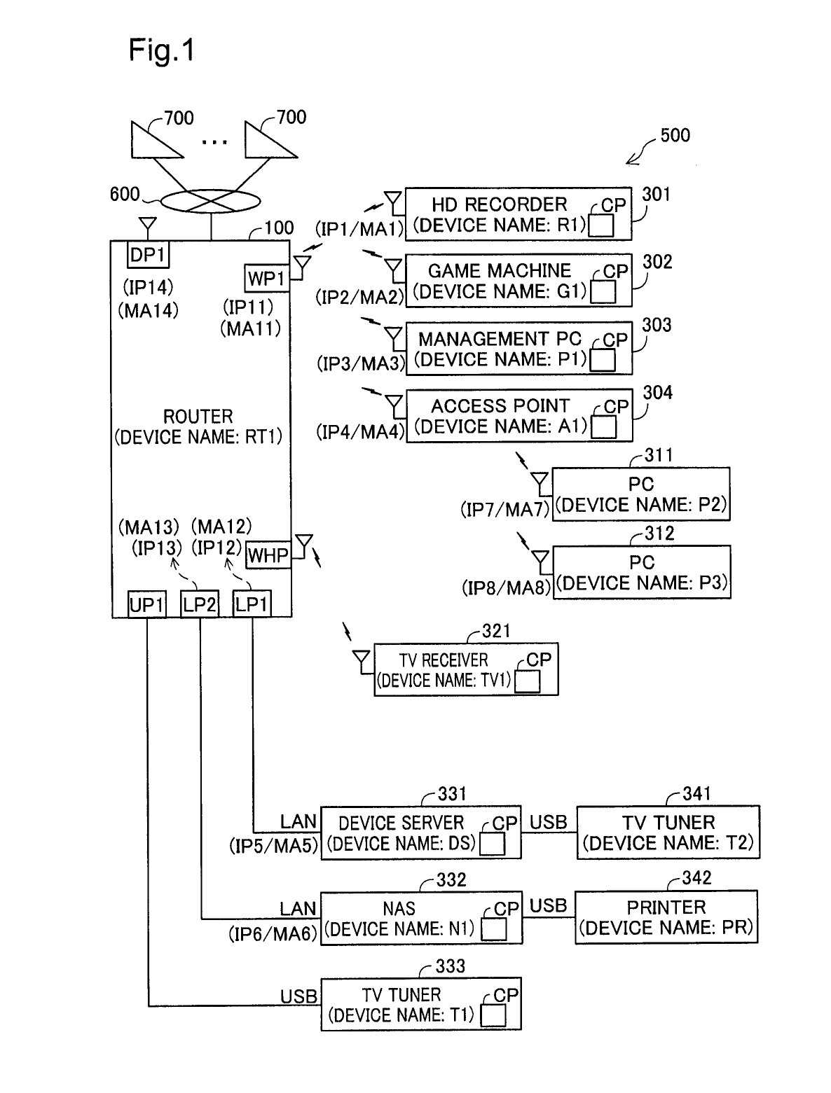

FIG. 1 illustrates the general configuration of a system, to which a management device according to one embodiment of the disclosure is applied. This system 500 includes a router 100 and a plurality of devices. More specifically, the system 500 includes the router 100, a hard disk recorder 301 a game machine 302, a management PC (personal computer) 303, a wireless LAN access point 304, two personal computers 311 and 312, a TV receiver 321, a device server 331, a TV tuner 341, an NAS (Network Attached Storage) 332, a printer 342 and a TV tuner 333. The system 500 serves to manage the connection configuration among the respective devices and the router 100, and the operating conditions of the respective devices, while allowing data transfer between the respective devices and data transfer between the respective devices and other devices connected to the Internet (for example, software management servers 700 describe later).

In the system 500 with the router 100 centered, the devices are connected via either a network interface or a bus interface. In the description of the embodiment, the “network interface” means a connection interface conforming to, for example, the IEEE802.3 standard or the IEEE802.11 standard or a connection interface allowing mutual access to a plurality of devices, such as PLC (Power Line Communications), whilst the “bus interface” means a connection interface allowing access to one connected device, such as USB (Universal Serial Bus) or WHDI (Wireless Home Digital Interface). A higher-level device (e.g., device server 331) connected with a lower-level device (e.g., TV tuner 341) by the bus interface is allowed to access to the lower-level device, while any other device (e.g., hard disk recorder 301) is not allowed to directly access to this lower-level device.

The hard disk recorder 301, the game machine 302, the management PC 303, the wireless LAN access point 304 and the TV receiver 321 are directly connected with the router 100 by wireless connection. The device server 331, the NAS 332 and the TV tuner 333 are directly connected with the router 100 by wired connection. The two personal computers 311 and 312 are, however, indirectly connected with the router 100 via the wireless LAN access point 304. The TV tuner 341 and the printer 342 are also indirectly connected with the router 100 via the device server 331 and via the NAS 332, respectively. The respective devices are connected in this manner with the router 100 centered, since the router 100 serves to relay data (packets) between devices and enables connection of devices having different connection interfaces. The system 500 of such connection configuration is adoptable in the home or small business. The expression that two devices are “connected” includes both the meanings that the two devices are directly connected and that the two devices are indirectly connected. The expression that the two devices are directly connected means that the two devices are connected without any intermediate device, whilst the expression that the two devices are indirectly connected means that the two devices are connected via another device. For example, the expression of “directly connected with the router 100” means “connected with the router 100 without any other device”, whilst the expression of “indirectly connected with the router 100” means “connected with the router 100 via another device”. It should be further noted that when two devices are directly connected, the connection is facilitated by a bus interface or network interface, as defined above. In other words, while there may be no device disposed between the two devices that are directly connected, these devices are still connected via a bus interface, a cable or wire, or a wireless connection.

The router 100 includes a mobile communication control circuit DP1, a wireless LAN control circuit WP1, a WHDI control circuit WHP, two connection ports LP1 and LP2 and a USB control circuit UP1. The detailed structure of the router 100 including these circuits and ports will be described later. The router 100 is a wireless LAN (Local Area Network) router to relay packets (layer 2 frames and layer 3 packets) between the connected devices. Additionally, the router 100 has a hard disk drive, which is shared by another device to provide the NAS functions. The router 100 also serves as a DHCP (Dynamic Host Configuration Protocol) server that allocates an IP address to each device using TCP/IP (Transmission Control Protocol/Internet Protocol) as the communication protocol, among the devices included in the system 500.

The router 100 is connected with a plurality of software management servers 700 via the network 600. The connection interface of the router 100 for the network 600 is omitted from the illustration of FIG. 1. Any network, such as LAN, the Internet or leased circuit may be adopted for the network 600. According to this embodiment, the plurality of software management servers 700 are servers provided individually for respective hardware manufacturers.

The hard disk recorder 301 includes a high-capacity hard disk and a wireless LAN control circuit. The hard disk recorder 301 is wirelessly connected with the router 100 by the wireless LAN control circuit. The hard disk recorder 301 records data received from the router 100, while reading out specified data and sending the read-out data to the router 100.

The game machine 302 includes a wireless LAN control circuit and is wirelessly connected with the router 100 by this wireless LAN control circuit. The game machine 302 transfers data on game contents (including voice and image data and data on operation details) to and from the router 100.

The management PC 303 is connected with the router 100 via a wireless LAN and manages the connection configuration of the respective devices in the system 500, the operating conditions of the respective devices and the software applied to the respective devices. The management PC 303 corresponds to the management device according to one embodiment of the disclosure. The details of the management PC 303 will be described later.

The wireless LAN access point 304 serves as a base station in the infrastructure mode, and wirelessly communicates with the two personal computers 311 and 312 serving as wireless LAN clients, while wirelessly communicating with the router 100 serving as the higher-level device.

Each of the two personal computers 311 and 312 includes a wireless LAN control circuit and wirelessly communicates with the wireless LAN access point 304 to transfer data via the wireless LAN.

The TV receiver 321 has an embedded TV tuner to receive TV airwaves (video signals and sound signals) and output video data and sound data. The TV receiver 321 also includes a WHDI control circuit to establish WHDI-based wireless communication with the router 100. The connection of the TV receiver 321 with the router 100 via WHDI enables, for example, the images and sounds output from the TV receiver 321 to be sent to the hard disk recorder 301 via the router 100 and stored in the hard disk recorder 301.

The device server 331 includes a USB control circuit and a wired LAN control circuit, and is connected with the TV tuner 341 by a USB cable and with the router 100 (connection port LP1) by a LAN cable. The device server 331 receives video data and sound data output from the TV tuner 341 according to a USB protocol and outputs the received video data and sound data in the form of wired LAN frames (e.g., Ethernet (registered trademark) frames) to the router 100. The device server 331, on the other hand, creates a USB frame from frames received from the router 100 and outputs the USB frame to the TV tuner 341. Using the device server 331 to connect the TV tuner 341 to a wired LAN enables, for example, the video data and sound data output from the TV tuner 341 to be sent to and recorded in the hard disk recorder 301 via the wired LAN or wireless LAN or to be sent to and reproduced by the TV receiver 321.

The TV tuner 341 receives TV airwaves and outputs video data and sound data. The TV tuner 341 includes a USB control circuit to send the video data and sound data to the device server 331 by USB.

The NAS 332 includes a high-capacity hard disk, a wired LAN control circuit and a USB control circuit and is connected with the router 100 (connection port LP2) by a LAN cable and with the printer 342 by a USB cable. The NAS 332 records data received from the router 100 or the printer 342, and reads out recorded data and outputting the read-out data to the router 100 or the printer 342.

The printer 342 is, for example, an inkjet printer and serves to receive images stored in the NAS 332 via the USB cable and print the received images. The printer 342 has image processing functions, for example, sharpness control and skin color control and sends and stores the processed images to and in the NAS 332 via the USB cable.

The TV tuner 333 includes a USB control circuit and outputs the received TV airwaves (video signals and sound signals) to the router 100 via the USB cable. Connecting the TV tuner 333 with the router 100 intends to achieve the same purposes as those by connecting the TV tuner 341 with the router 100 via the device server 331 described above. In one expected application, the TV tuner 341 may be placed, for example, in a child's room, while the TV tuner 333 may be placed, for example, in a living room.

In the system 500, an IP (Internet Protocol) address is allocated to each of the devices connected to either the wireless LAN or the wired LAN, in order to allow TCP/IP-based communication. More specifically, an IP address “IP11” is allocated to the wireless LAN control circuit WP1 of the router 100, an IP address “IP12” to the connection port LP1 of the router 100, an IP address “IP13” to the connection port LP2 of the router 100, and an IP address “IP14” to the mobile communication control circuit DP1 of the router 100. IP addresses “IP1”, “IP2”, “IP3”, “IP4”, “IP5”, “IP6”, “IP7” and “IP8” are respectively allocated to the hard disk recorder 301, the game machine 302, the management PC 303, the wireless LAN access point 304, the device server 331, the NAS 332, the personal computer 311 and the personal computer 312. Although the respective IP addresses are represented by symbolic values for the convenience of explanation, a 32-bit address (IPv4) or a 128-bit address (IPv6) is actually allocated to each device. In the system 500, the router 100 (DHCP server) allocates an IP address to each device when the device enters the wireless LAN or the wired LAN.

A MAC (Media Access Control) address is allocated to each of the devices connected to either the wireless LAN or the wired LAN, in order to allow communication conforming to the IEEE802.3 standard, such as Ethernet (registered trademark). Specifically, a MAC address “MA11” is allocated to the wireless LAN control circuit WP1 of the router 100, a MAC address “MA12” to the connection port LP1 of the router 100, a MAC address “MA13” to the connection port LP2 of the router 100, and a MAC address “MA14” to the mobile communication control circuit DP1 of the router 100. MAC addresses “MA1”, “MA2”, “MA3”, “MA4”, “MA5”, “MA6”, “MA7” and “MA8” are respectively allocated to the hard disk recorder 301, the game machine 302, the management PC 303, the wireless LAN access point 304, the device server 331, the NAS 332, the personal computer 311 and the personal computer 312. Although the respective MAC addresses are represented by the symbolic values for the convenience of explanation, a 48-bit address is actually allocated to each device.

A device name is set in each of the devices included in the system 500. Specifically, a device name “RT1” is set to the router 100, a device name “R1” to the hard disk recorder 301, “G1” to the game machine 301, “P1” to the management PC 303, “A1” to the wireless LAN access point 304, “P2” to the personal computer 311, “P3” to the personal computer 312, “TV1” to the TV receiver 321, “DS” to the device server 331, “N1” to the NAS 332, “T1” to the TV tuner 333, “T2” to the TV tuner 341 and “PR” to the printer 342. The device names for the respective devices may be set, for example, before shipment and stored in nonvolatile memories (e.g., EEPROMs) of the respective devices.

In the system 500, some of the devices connected with the router 100 have a configuration information acquisition-relevant module CP. Specifically, the hard disk recorder 301, the game machine 302, the management PC 303, the wireless LAN access point 304, the TV receiver 321, the device server 331, the NAS 332 and the TV tuner 333 have the configuration information acquisition-relevant module CP. The configuration information acquisition-relevant module CP performs a configuration information gathering process described later. None of the two personal computers 311 and 312, the TV tuner 341 and the printer 342, however, has the configuration information acquisition-relevant module CP.

A2. Structure of Router

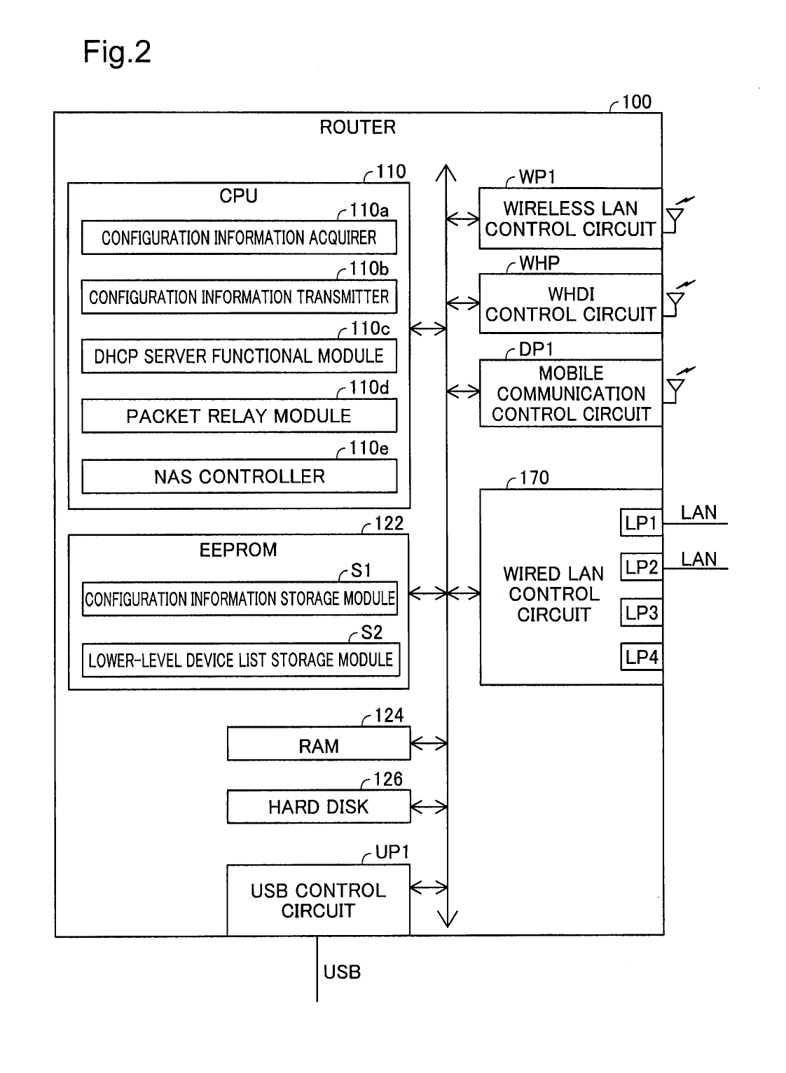

FIG. 2 is a block diagram illustrating the detailed structure of the router shown in FIG. 1. The router 100 includes a CPU (Central Processing Unit) 110, an EEPROM (Electrically Erasable and Programmable Read Only Memory) 122, a RAM (Random Access Memory) 124, a hard disk 126, the USB control circuit UP1, the wireless LAN control circuit WP1, the WHDI control circuit WHP, the mobile communication control circuit DP1, and a wired LAN control circuit 170, which are connected by an internal bus.

A preset application program is stored in the EEPROM 122, and the CPU 110 performs this application program under a specific operating system to serve as a configuration information acquirer 110a, a configuration information transmitter 110b, a DHCP server functional module 110c, a packet relay module 110d and an NAS controller 110e.

The configuration information acquirer 110a is a functional module to obtain the own configuration information and the configuration information of other devices. According to this embodiment, the “configuration information” includes information on the device type, the device name, the connection interface type with another device, the operating condition, the applied software name and the software version. The configuration information transmitter 110b sends the configuration information obtained by the configuration information acquirer 110a to the management PC 303. The DHCP server functional module 110c functions as a DHCP server to allocate an IP address and a subnet mask to each device and provide information, such as address of a gateway server. The packet relay module 110d relays an IP packet received via each of the interfaces included in the router 100, based on the IP address. The NAS controller 110e manages access control and storage areas when the router 100 serves as the NAS with using the hard disk 126 as a shared disk.

The EEPROM 122 includes a configuration information storage module S1 and a lower-level device list storage module S2. The configuration information storage module S1 stores the configuration information obtained from other devices, in addition to the own configuration information. The own configuration information includes, for example, the device name as the router, the remaining capacity of the embedded hard disk 126, the received signal strength from each device connected by the wireless LAN, the type of each interface included in the router 100 (wireless LAN, wired LAN, WHDI or USB), the operating condition of each circuit (e.g., during normal operation or during wireless connection), an association list of the wireless LAN, the applied software name and the software version information. These information may be obtained by an initialization sequence (for example, USB enumeration) defined in each interface, for example, at the start-up of the router 100 or on connection of a USB device to the router 100. These information may also be obtained by the configuration information gathering process described later. The lower-level device list storage module S2 stores a lower-level device list described later.

The wireless LAN control circuit WP1 includes a modulator, an amplifier and an antenna and serves as a wireless LAN access point conforming to, for example, the IEEE802.11b/g standard to wirelessly communicate with the hard disk recorder 301, the game machine 302 and the management PC 303 as wireless LAN clients. The wireless LAN control circuit WP1 also wirelessly communicates with the wireless LAN access point 304 serving as another wireless LAN access point.

The WHDI control circuit WHP includes a modulator, an amplifier and an antenna and performs WHDI-based wireless communication (near field wireless communication in a frequency range of 5 GHz). The mobile communication control circuit DP1 includes a modulator, an amplifier and an antenna and serves as a mobile communications station conforming to, for example, the 3G/HSPA protocol to wireless communicate with an access point of a mobile communications network.

The wireless LAN control circuit 170 has four connection ports LP1 to LP4 and is involved in reception and transmission of frames in conformity with the IEEE802.3 standard, creation of an IP packet from received frames (layer 2 frames), and division of an IP packet including data to be output into frames (layer 2 frames).

A3. Structure of Management PC

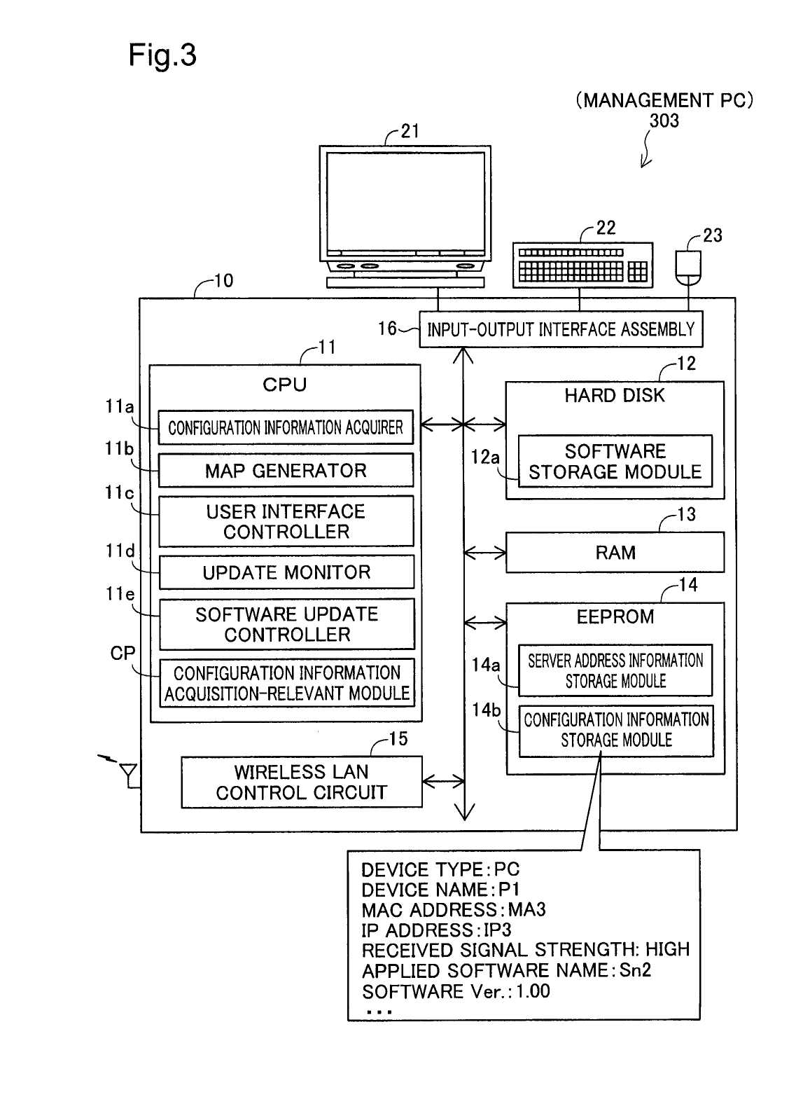

FIG. 3 illustrates the general structure of the management PC shown in FIG. 1. The management PC 303 includes a computer body 10, a display 21, a keyboard 22 and a mouse 23. The computer body 10 includes a CPU 11, a hard disk 12, a RAM 13, an EEPROM 14, a wireless LAN control circuit 15 and an input-output interface assembly 16. An application program for management of the system 500 is stored in a software storage module 12a of the hard disk 12, and the CPU 11 performs this application program under a specific operating system to serve as a configuration information acquirer 11a, a map generator 11b, a user interface controller 11c, an update monitor 11d, a software update controller 11e and a configuration information acquisition-relevant module CP.

The configuration information acquirer 11a obtains the configuration information of the respective devices included in the system 500, as well as the own configuration information. The map generator 11b generates a system configuration map for centralized management of, for example, the configuration information of the respective devices included in the system 500 and the operating conditions of the respective devices. The user interface controller 11c causes the configuration map generated by the map generator 11b to be displayed in a user-identifiable display format on the display 21. The user interface controller 11c also receives and accepts the user's various operations of the keyboard 22 and the mouse 23. The update monitor 11d monitors whether the software stored in the software management servers 700 is updated (i.e., whether the software of the newer version is stored) at regular intervals. The software update controller 11e applies the software of the newer version obtained from each of the software management servers 700 to a target device. The configuration information acquisition-relevant module CP obtains the configuration information of the management PC 303 and notifies the router 100 of the obtained configuration information. This configuration information acquisition-relevant module CP has the same functions as those of the configuration information acquisition-relevant modules CP provided in the devices shown in FIG. 1 (e.g., hard disk recorder 301 and game machine 302).

The wireless LAN control circuit 15 includes a modulator, an amplifier and an antenna and serves as a wireless LAN client conforming to, for example, the IEEE802.11b/g standard.

The EEPROM 14 has a server address information storage module 14a and a configuration information storage module 14b. Address information of each software management server 700 (for example, IP address, net mask or URL) is stored in the server address information storage module 14a. The own configuration information of the management PC 303 and the configuration information of other devices are stored in this configuration information storage module 14b. In the illustrated example of FIG. 3, the device type “PC”, the device name “P1”, the MAC address “MA3”, the IP address “IP3”, the received signal strength “high”, the applied software name “Sn2” and the software version “1.00” are stored in the configuration information storage module 14b as part of the own configuration information of the management PC 303. The applied software may be, for example, the firmware for the wireless LAN control circuit 15. Another example may be an application program for the personal computer to specify various settings relating to the operations of the wireless LAN control circuit 15 and to check the operating conditions. Other examples may include antivirus software and update software for the operating system. The software to be registered as the configuration information may be preset, for example, by the user (system administrator).

The input-output interface assembly 16 includes a group of interfaces used to connect the display 21, the keyboard 22 and the mouse 23 with the computer body 10.

A4. Structure of Other Device

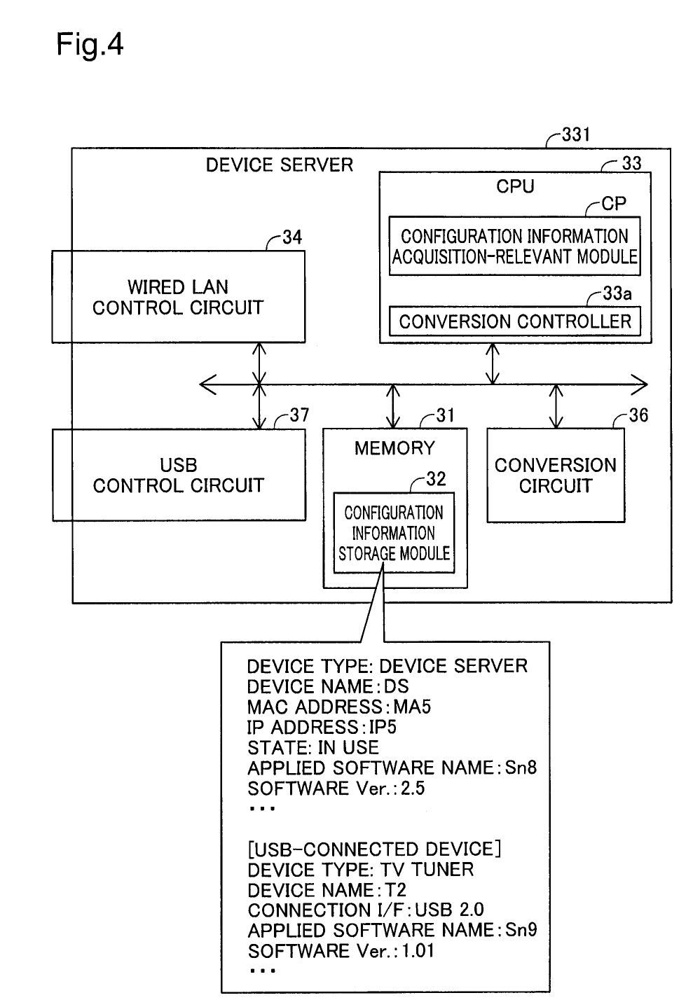

FIG. 4 illustrates the general structure of the device server shown in FIG. 1. The device server 331 includes a memory 31, a CPU 33, a wired LAN control circuit 34, a conversion circuit 36 and a USB control circuit 37.

The memory 31 consists of, for example, a RAM and an EEPROM and has a configuration information storage module 32. The configuration information storage module 32 stores the own configuration information of the device server 331 and the configuration information of each device connected with the device server 331. In the illustrated example of FIG. 4, the device type “device server”, the device name “DS”, the MAC address “MA5”, the IP address “IP5”, the operating condition “in use”, the applied software name “Sn8” and the software version “2.5” are stored in the configuration information storage module 32 as part of the own configuration information of the device server 331. The applied software may be, for example, firmware for the device server 331. The configuration information on the TV tuner 341 connected with the device server 331 (i.e., device type “TV tuner”, device name “T2”, connection interface type “USB2.0”, applied software name “Sn9” and software version “1.01”) is also stored in the configuration information storage module 32. The applied software may be, for example, firmware for the TV tuner 341.

The CPU 33 performs a program stored in the memory 31 to serve as a configuration information acquisition-relevant module CP and a conversion controller 33a. The configuration information acquisition-relevant module CP has the similar functions to those of the configuration information acquisition-relevant module CP of the management PC 303 shown in FIG. 3. The conversion controller 33a controls the operations of the conversion circuit 36.

Like the wired LAN control circuit 170 shown in FIG. 2, the wired LAN control circuit 34 is involved in reception and transmission of frames conforming to the IEEE802.3 standard. The conversion circuit 36 converts a frame in conformity with the IEEE802.3 standard into a USB2.0 format, or vice versa. The USB control circuit 37 is involved in reception and transmission of data according to the USB2.0 protocol.

The device server 331 shown in FIG. 4 has the configuration information acquisition-relevant module CP and the configuration information storage module 32 unlike the conventional device server, but otherwise has the same structure as that of the conventional device server. Similarly, each of the other devices with the configuration information acquisition-relevant module CP but the management PC 303 (i.e., hard disk recorder 301, game machine 302, wireless LAN access point 304, TV receiver 321, NAS 332 and TV tuner 333) has the configuration information acquisition-relevant module CP and a corresponding configuration information storage module unlike the conventional corresponding device, but otherwise has the same structure as that of the conventional corresponding device.

In the system 500 of the above configuration, the configuration information gathering process described below enables the user to easily manage the connection configurations and the operating conditions of the respective devices included in the system 500. Additionally, the system 500 performs the software update process described below to readily update the software (e.g., firmware and applications) applied to the respective devices.

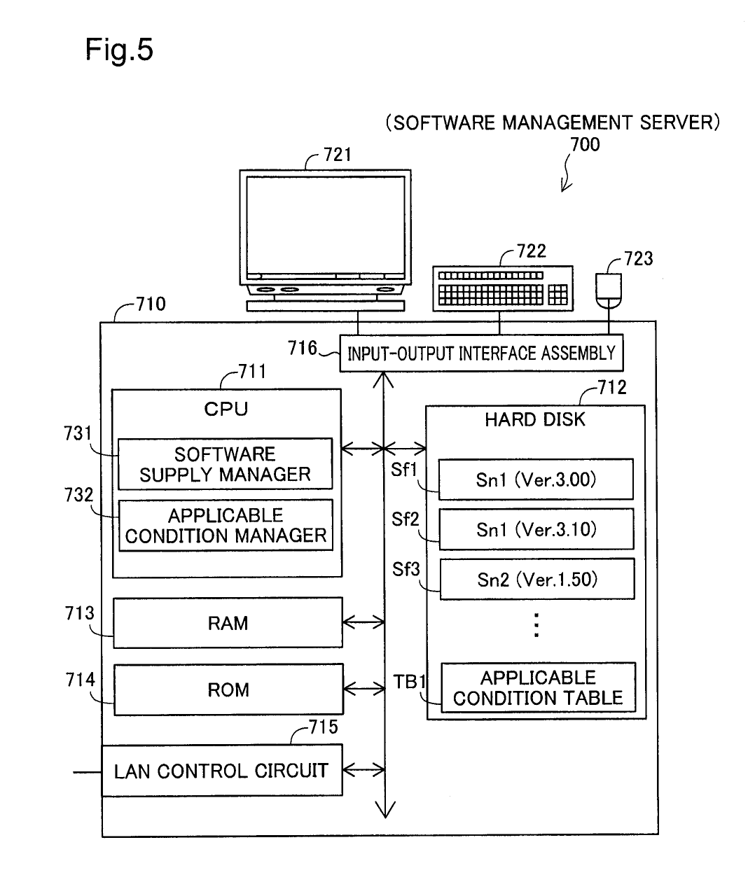

FIG. 5 illustrates the general structure of the software management server shown in FIG. 1. The software management server 700 is not included in the components of the system 500. The software management server 700 includes a computer body 710, a display 721, a keyboard 722 and a mouse 723. The computer body 710 includes a CPU 711, a hard disk 712, a RAM 713, a ROM 714, a wireless LAN control circuit 715 and an input-output interface assembly 716.

The software for the respective devices included in the system 500 is stored in the hard disk 712. Among various software, software Sf1 having the software name “Sn1” and the version “3.00”, software Sf2 having the software name “Sn1” and the version “3.10” and software Sf3 having the software name “Sn2” and the version “1.50” are shown as examples in FIG. 5. As clearly understood from the same software name “Sn1”, the software Sf1 and the software Sf2 are the software of different versions to be applied to an identical device. An applicable condition table TB1 is stored in the hard disk 712.

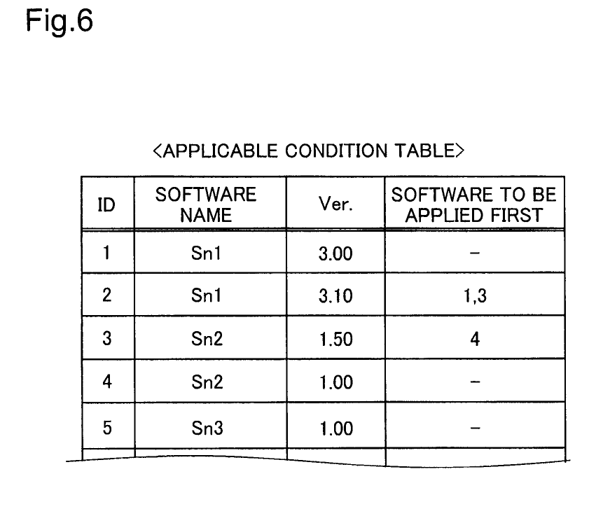

FIG. 6 shows the settings of the applicable condition table shown in FIG. 5. The applicable condition table TB1 records the conditions for applying the respective software stored in the hard disk 712. The applicable condition table TB1 may be preset by the user (system administrator).

As shown in FIG. 6, the applicable condition table TB1 has an ID field, a software name field, a version field and a “software to be applied first” field, which are correlated to one another. The number in the ID field represents the ID of each entry. The data in the software name field represents the software name of each entry. The value in the version field represents the version of the software having the software name set in the software name field. The value in the “software to be applied first” field represents the software to be applied prior to the software of the entry. The software to be applied first is specified by the number set in the ID field. For example, the ID “4” is set as the parameter for specifying the “software to be applied first” with respect to the software of the ID “3” (i.e., software having the software name “Sn2” and the version “1.50”). This means that the software of the ID “4” (i.e., software having the software name “Sn2” and the version “1.00”) should be applied prior to the software of the ID “3”. The symbol “-” set in the “software to be applied first” field means that there is no software to be applied prior to the software of the entry.

FIG. 6 shows five entries as an example. More specifically, the applicable condition table TB1 includes (i) entry of ID “1”, software name “Sn1”, version “3.00” and software to be applied first “-”, (ii) entry of ID “2”, software name “Sn1”, version “3.10” and software to be applied first “1, 3”, (iii) entry of ID “3”, software name “Sn2”, version “1.50” and software to be applied first “4”, (iv) entry of ID “4”, software name “Sn2”, version “1.00” and software to be applied first “-”, and (v) entry of ID “5”, software name “Sn3”, version “1.00” and software to be applied first “-”.

The CPU 711 shown in FIG. 5 performs an application program stored in the hard disk 712 under a specific operating system to server as a software supply manager 731 and an applicable condition manager 732. The software supply manager 731 supplies the corresponding software stored in the hard disk 712, in response to an external download request. The applicable condition manager 732 updates the applicable condition table TB1, in response to the user's instructions input through the operations of the keyboard 722 and the mouse 723.

The input-output interface assembly 716 includes a group of interfaces used to connect the display 721, the keyboard 722 and the mouse 723 with the computer body 710.

The router 100 corresponds to the gateway device in the claims. The device name of each device corresponds to the device specific information in the claims, the software name and the version to the software identification information in the claims, the update monitor 11d to the software acquirer in the claims, the software update controller 11e to the software application controller in the claims, the configuration information acquirer 11a of the management PC 303 to the configuration information acquirer and the log information acquirer in the claims, the display 21 to the display unit in the claims, the map generator 11b and the user interface controller 11c to the map display controller in the claims, the software Sf1 and the software Sf3 or the software Sf2 and the software Sf3 to the first software and the second software in the claims, the software Sf1 and the software Sf2 to the plurality of software in the claims, and the applicable condition table TB1 to the table in the claims.

A5. Configuration Information Gathering Process

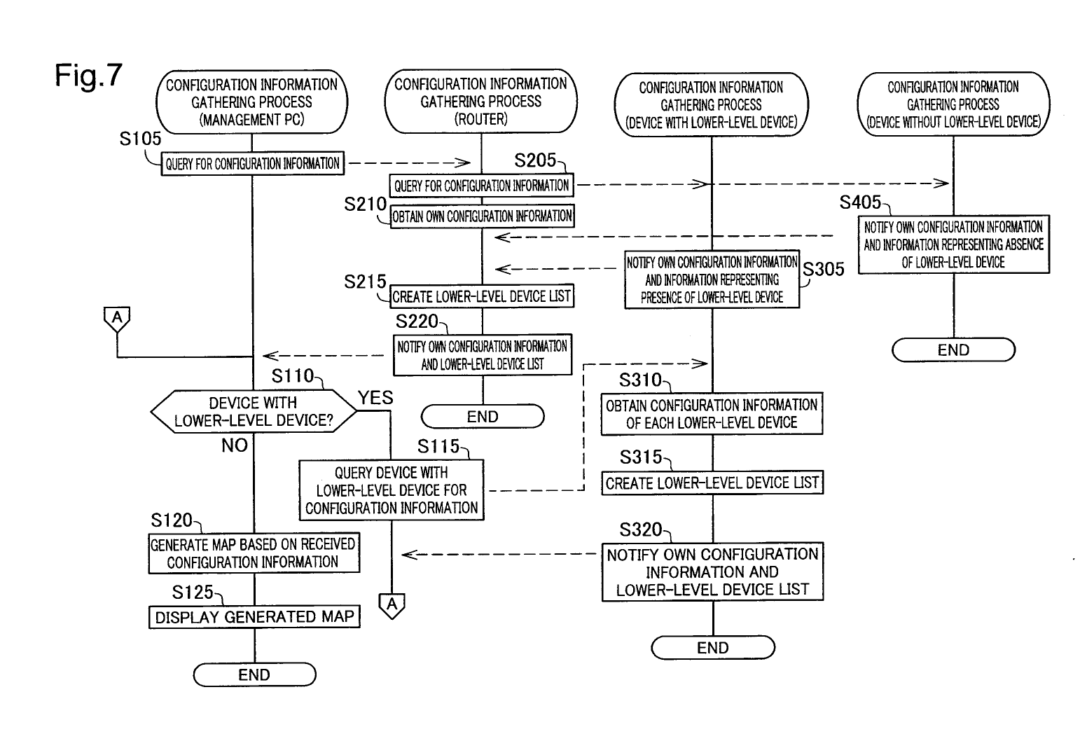

FIG. 7 is a sequence diagram showing a procedure of configuration information gathering process according to the first embodiment. The leftmost flow shows the processing flow of the management PC 303. The second left flow, the third left flow and the rightmost flow respectively show the processing flow of the router 100, the processing flow of a device with any lower-level device but the router 100 and the processing flow of a device without any lower-level device. The “lower-level device” of a target device herein means a device connected to the target device, such as to be more distant from the router 100 (i.e., a greater number of devices intervening before the router 100) than the target device. For example, the devices directly connected with the router 100 by wired connection or by wireless connection (i.e., hard disk recorder 301, game machine 302, management PC 303, wireless LAN access point 304, TV receiver 321, device server 331, NAS 332 and TV tuner 333) are the lower-level devices of the router 100. The two personal computers 311 and 312 are the lower-level devices of the wireless LAN access point 304. In other words, the wireless LAN access point 304 is the device with arbitrary lower-level device (two personal computers 311 and 312). Similarly, the device server 331 is the device with arbitrary lower-level device (TV tuner 341), and the NAS 332 is the device with arbitrary lower-level device (printer 342). The hard disk recorder 301, the game machine 302, the management PC 303, the TV receiver 321 and the TV tuner 333 are, on the other hand, the devices without arbitrary lower-level device.

In the system 500, after the start-up of the management PC 303, the configuration information gathering process is performed at preset intervals. The configuration information acquirer 11a of the management PC 303 shown in FIG. 3 first queries the router 100 for configuration information (step S105). In an application that the management PC 303 and the router 100 are devices conforming to DLNA (Digital Living Network Alliance) and that the management PC 303 and the router 100 respectively serves as a DMP (Digital Media Player) and as a DMS (Digital Media Server), the management PC 303 may adopt, for example, the GET method to require device description of the router 100 to implement the query for configuration information. The address of the router 100 required for the query to the router 100 may be obtained, for example, from the settings in the management PC 303.

In response to the query from the management PC 303, the configuration information acquirer 110a of the router 100 shown in FIG. 2 queries each lower-level device for configuration information (step S205). This query may be performed in the same manner as the query at step S105 described above.

In response to the query for configuration information from the router 100, the device with arbitrary lower-level device gathers the own configuration information and replies back this own configuration information and information representing the presence of lower-level device to the router 100 (step S305). For example, the configuration information acquisition-relevant module CP of the device server 331 shown in FIG. 4 reads out the own configuration information (i.e., device type, device name, MAC address, IP address, operating condition, applied software name and software version) stored in the configuration information storage module 32 and sends this own configuration information and information representing the presence of lower-level device to the router 100. The configuration information acquisition-relevant module CP may query the conversion controller 33a for any device connected to the USB control circuit, in order to check whether the device server 331 has any lower-level device (i.e., whether the device server 331 has any USB-connected device).

As shown in FIG. 7, in response to the query for configuration information from the router 100, the device without any lower-level device, on the other hand, gathers the own configuration information and replies back this own configuration information and information representing the absence of lower-level device to the router 100 (step S405). For example, the configuration information acquisition-relevant module CP of the management PC 303 reads out the own configuration information (i.e., device type, device name, MAC address, IP address, received signal strength, applied software name and software version) stored in the configuration information storage module 14b and sends this own configuration information to the router 100.

After querying each lower-level device for configuration information (step S205), the configuration information acquirer 110a of the router 100 obtains the own configuration information and stores the own configuration information into the configuration information storage module S1 (step S210). For example, the configuration information acquirer 110a may query the mobile communication control circuit DP1 for operating condition, obtain the operating condition of “during communication” and store the operating condition into the configuration information storage module S1. In another example, the configuration information acquirer 110a may query the NAS controller 110e for used capacity of the hard disk 126, obtain the operating condition of “80% in use” and store the operating condition into the configuration information storage module S1.

The configuration information acquirer 110a of the router 100 stores the configuration information received from each lower-level device into the configuration information storage module S1 shown in FIG. 2, while creating a lower-level device list based on the received configuration information and storing the created lower-level device list into the lower-level device list storage module S2 (step S215).

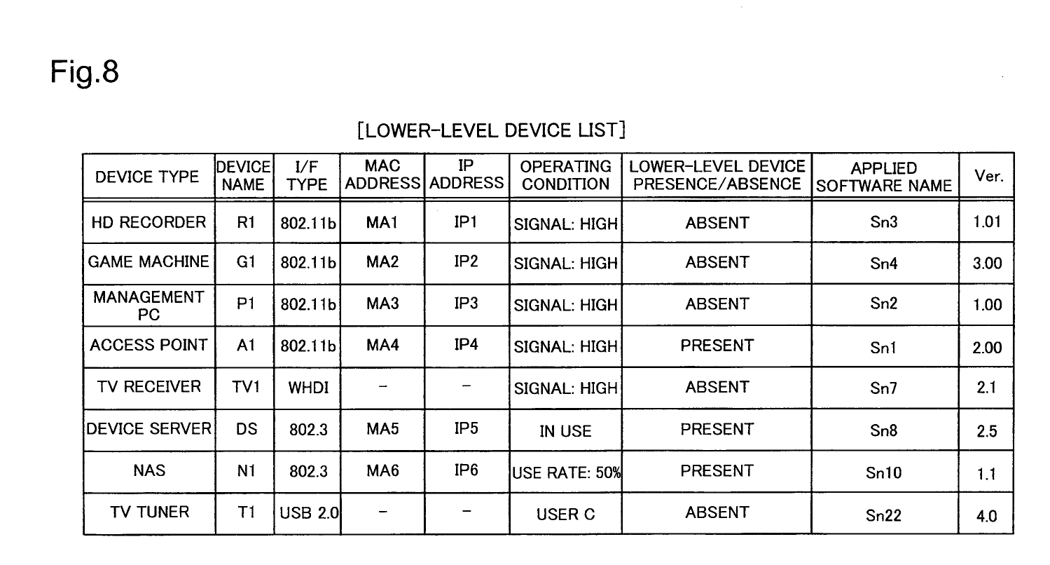

FIG. 8 illustrates an example of the lower-level device list created at step S215. As shown in FIG. 8, the lower-level device list records the device type, the device name, the interface (I/F) type, the MAC address, the IP address, the operating condition, the presence or absence of lower-level device, the applied software name and the software version with respect to each of the lower-level devices of the router 100. For example, the device type “hard disk recorder”, the device name “R1”, the I/F type “802.11b”, the MAC address “MA1”, the IP address “IP1”, the operating condition “signal: high”, the lower-level device presence/absence “absent”, the applied software name “Sn3” and the software version “1.01” are recorded with respect to the hard disk recorder 301.

The configuration information transmitter 110b of the router 100 sends the own configuration information obtained at step S210 and the lower-level device list created at step S215 to the management PC 303 (step S220).

When receiving the lower-level device list, the configuration information acquirer 11a of the management PC 303 stores the received lower-level device list into the configuration information storage module 14b and checks for the presence or absence of any lower-level device with respect to each of the devices enumerated in the lower-level device list (step S110) and queries each device with any lower-level device for configuration information (step S115). The devices with any lower-level device other than the router 100 in the system 500 include the wireless LAN access point 304, the device server 331 and the NAS 332. These devices have the setting of “present” in the lower-level device presence/absence field in the lower-level device list as shown in FIG. 8. The configuration information acquirer 11a of the management PC 303 can thus check for the presence or absence of any lower-level device with respect to each device, based on the setting in this field. The addresses of the device with any lower-level device (MAC address and IP address) may be obtained from the lower-level device list.

As shown in FIG. 7, when receiving the query for configuration information from the management PC 303, the configuration information acquisition-relevant module CP of the device with any lower-level device obtains the configuration information of each lower-level device (step S310). For example, the configuration information of each lower-level device may be obtained by sending a configuration information notification request (e.g., http command) to each lower-level device and receiving a reply from the lower-level device. More specifically, the configuration information acquisition-relevant module CP of the wireless LAN access point 304 may send a configuration information notification request to the two personal computers 311 and 312. In another example, the configuration information of each lower-level device may be obtained by reading out the configuration information, which has been obtained in the initialization sequence on connection of the lower-level device and stored in the memory of the lower-level device. More specifically, the configuration information acquisition-relevant module CP of the device server 331 may read out the configuration information (device type “TV tuner”, device name “T2”, and connection interface type “USB2.0”) obtained in the initialization sequence on USB connection of the TV tuner 341 and stored in the configuration information storage module 32.

After obtaining the configuration information of each lower-level device, the configuration information acquisition-relevant module CP of the device with any lower-level device creates a lower-level device list (step S315) and sends the created lower-level device list and the own configuration information to the management PC 303 (step S320). The items of the respective columns in the lower-level device list created at step S315 are equal to those of the lower-level device list shown in FIG. 8.

When receiving the lower-level device list from the device with any lower-level device after step S115, the configuration information acquirer 11a of the management PC 303 performs step S110 described above again (i.e., checking for the presence or absence of any lower-level device with respect to each of the devices enumerated in the newly received lower-level device list). The lower-level device lists received from the plurality of devices may be stored as separate lists in the configuration information storage module 14b. Alternatively, the lower-level device lists received from the plurality of devices may be summarized in the form of one list and stored in the configuration information storage module 14b.

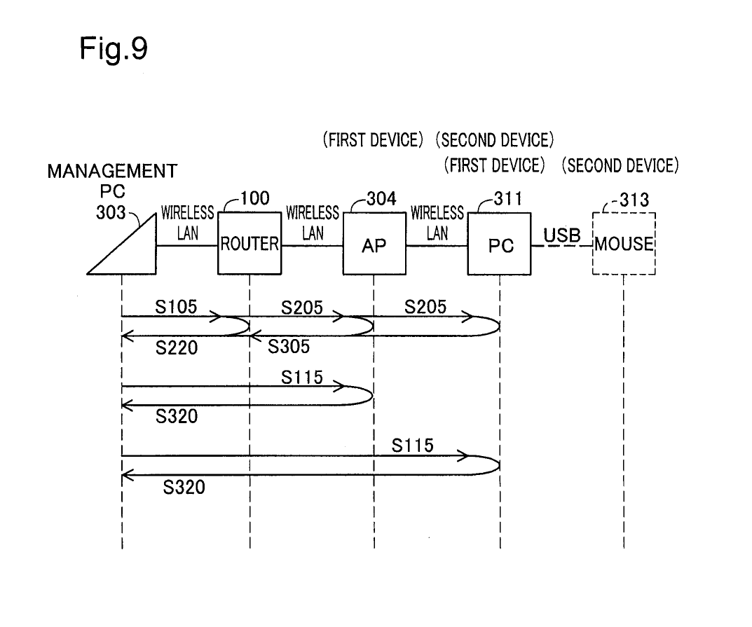

FIG. 9 schematically illustrates one example of configuration information gathering according to the first embodiment. FIG. 9 schematically shows the processing flow when the management PC 303 gathers the configuration information from the router 100, the wireless LAN access point 304 and the personal computer 311.

The management PC 303 obtains the configuration information and the lower-level device list of the router 100 from the router 100 at step S105 and S220. In response to the query at step S105, the query for configuration information (S205) and the reply (S305) is performed between the router 100 and the wireless LAN access point 304 or the personal computer 311. The lower-level device list obtained from the router 100 includes the MAC address and the IP address of each of the devices with any lower-level device as shown in FIG. 8. The management PC 303 accordingly obtains the configuration information and the lower-level device list of the wireless LAN access point 304 from the wireless LAN access point 304 at steps S115 and S320. Similarly, the management PC 303 refers to the lower-level device list obtained from the wireless LAN access point 304 and obtains the configuration information and the lower-level device list of the personal computer 311 from the personal computer 311 at steps S115 and S320. As shown by the broken line in FIG. 9, when the mouse 313 is connected with the personal computer 311 by USB interface, the personal computer 311 creates and sends a lower-level device list including the mouse 313 to the router 100.

The procedure of this embodiment repeats the processing of steps S110 and S115 in this manner until any of the lower-level devices has any further lower-level device having non-gathered configuration information. The personal computer 311 is the lower-level device of the wireless LAN access point 304 and is also the device with the mouse 313 as its lower-level device. In the combination (pair) of the wireless LAN access point 304 and the personal computer 311, the wireless LAN access point 304 corresponds to the first device (previous first device) in the claims of the disclosure, while the personal computer 311 corresponds to the second device (previous second device) in the claims. In the pair of the personal computer 311 and the mouse 313, the personal computer 311 corresponds to the first device (current first device) in the claims, while the mouse 313 corresponds to the second device (current second device) in the claims. Sequentially sliding the pairing of two devices to change a certain device from the previous second device to the current first device should be regarded in the scope of the claims of the disclosure.

The connection interface in the pair of the wireless LAN access point 304 and the personal computer 311 is the network interface (wireless LAN), whilst the connection interface in the pair of the personal computer 311 and the mouse 313 is the bus interface (USB). According to this embodiment, irrespective of whether the connection interface between the first device and the second device is the network interface or the bus interface, the first device obtains the configuration information of the second device and notifies the management PC 303 of the obtained configuration information.

Referring back to FIG. 7, when the lower-level device list does not include any device having any lower-level device having non-gathered configuration information (step S110: No), the map generator 11b of the management PC 303 performs a map generation process to generate a system configuration map, based on the received configuration information and lower-level device list of the router 100 (step S120). The user interface controller 11c of the management PC 303 displays the system configuration map generated at step S120 on the display 21 (step S125).

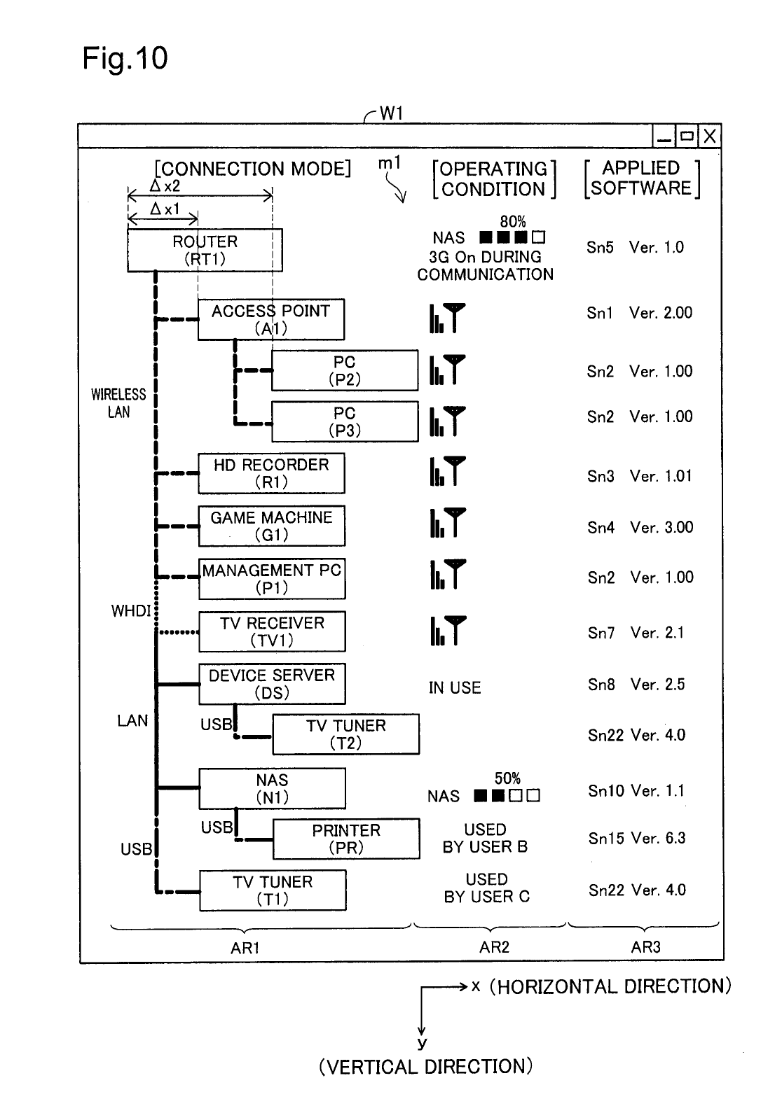

FIG. 10 illustrates an exemplary system configuration map displayed on the display as the result of the map generation process. A system configuration map m1 shown in FIG. 10 is generated at step S120 and is displayed in a window W1 on the display 21. The longitudinal direction (y direction) of the window W1 is parallel to the vertical direction, and the lateral direction (x direction) of the window W1 is parallel to the horizontal direction.

The system configuration map m1 includes a connection mode display area AR1, an operating condition display area AR2 and a software information display area AR3. Symbols representing the respective devices included in the system 500, the device types and the device names of the respective devices, and the connection interface types between the respective devices are displayed in the connection mode display area AR1. The operating conditions of the respective devices included in the system 500 are displayed in the operating condition display area AR2. The software names and the versions of the software applied to the respective devices are displayed in the software information display area AR3

As shown in FIG. 10, the symbols representing the respective devices included in the system 500 are arrayed in the y direction (vertical direction) from the router 100 as the starting point in the connection mode display area AR1. The symbols of the respective devices are rectangles of the same size, and the device type and the device name of each device are shown in the corresponding symbol.

The symbols of the respective devices are disposed in the connection mode display area AR1 to clarify the hierarchical structure of the respective devices. Specifically, the symbol of the router 100 is located at the uppermost left position. The symbol of each device directly connected with the router 100 by wireless connection or by wired connection is located at offset Δx1 right in the x direction (horizontal direction) from the symbol of the router 100. The symbol of each device not directly connected with the router 100 is, on the other hand, located at offset Δx2 right in the x direction (horizontal direction) from the symbol of the router 100, wherein the offset Δx2 is greater than the offset Δx1. The respective symbols are accordingly displayed, such that the router 100 is located at the highest hierarchical level, the devices directly connected with the router 100 are located at the second hierarchical level, and the devices not directly connected with the router 100 are located at the third hierarchical level, as shown in FIG. 10. Such hierarchical arrangement of the symbols representing the respective devices enables the user to readily understand the connections between the respective devices.

The symbols of the respective devices are grouped by the connection interface type with the router 100. More specifically, the symbols of the devices having the wireless LAN as the connection interface type are grouped first to be arranged at the closest position to the symbol of the router 100 in the y direction. Similarly, the symbols of the devices having the WHDI as the connection interface type, the symbols of the devices having the wired LAN as the connection interface type, and the symbols of the devices having the USB as the connection interface type are sequentially grouped to be arranged at the second closest position, at the third closest position, and at the fourth closest position, to the symbol of the router 100. Such grouping display of the symbols of the devices by the connection interface type with the router 100 enables the user to readily understand how many devices are connected for each type of the connection interface. Additionally, the symbols of the devices having the wireless connection interface with the router 100 are located at the position closer to the symbol of the router 100 in the y direction than the symbols of the devices having the wired connection interface with the router 100, because of the following reason. With respect to the devices having the wired connection interface with the router 100, it is relatively easy to identify which device is connected with the router 100 by tracking the cables used for connection. With respect to the devices having the wireless connection interface with the router 100, on the other hand, it is not easy to identify whether each device is connected with or not connected with the router 100. The management PC 303 accordingly locates the symbols of the devices having the wireless connection interface at the position closer to the symbol of the router 100 in the y direction, in order to clearly identify whether each device is connected with or not connected with the router 100.

The respective symbols are connected by different line types corresponding to the different connection interface types. This allows clear differentiation among the connection interface types for the respective devices. The connection lines between the symbols are also displayed corresponding to the actual connections between the devices. More specifically, for example, the symbol of the router 100 and the symbol of the wireless LAN access point 304 are directly connected by a broken line. The symbols of the two personal computers 311 and 312 are, however, not directly connected with the symbol of the router 100 but are directly connected with the wireless LAN access point 304 by broken lines. Displaying the connection lines between the symbols corresponding to the actual connections between the devices enables the user to readily understand the actual connection configuration.

As shown in FIG. 10, information showing the operating condition of each device is displayed at the position corresponding to the symbol of the device (i.e., the position adjacent to the symbol of the device in the horizontal direction) in the operating condition display area AR2. More specifically, for example, information showing that 80% of the capacity of the hard disk 126 is being used and information showing that the mobile communication control circuit DP1 is active (ON) and is during communication are displayed at the position corresponding to the symbol of the router 100. In another example, a symbol representing that the router 100 receives the “high” signal strength from the wireless LAN access point 304 is displayed at the position corresponding to the symbol of the wireless LAN access point 304. Information showing that the printer 342 is being used by the user B (i.e., is performing a print job sent from the user B) is displayed at the position corresponding to the symbol of the printer 342.

As described above, arraying the symbols of the respective devices in the vertical direction enables the space for displaying the operating condition of each device to be provided adjacent to the symbol of the device in the horizontal direction. This enables the user to readily understand the connection configuration of the respective devices, together with the operating conditions of the respective devices. The system configuration map m1 shown in FIG. 10 corresponds to the connection configuration map in the claims.

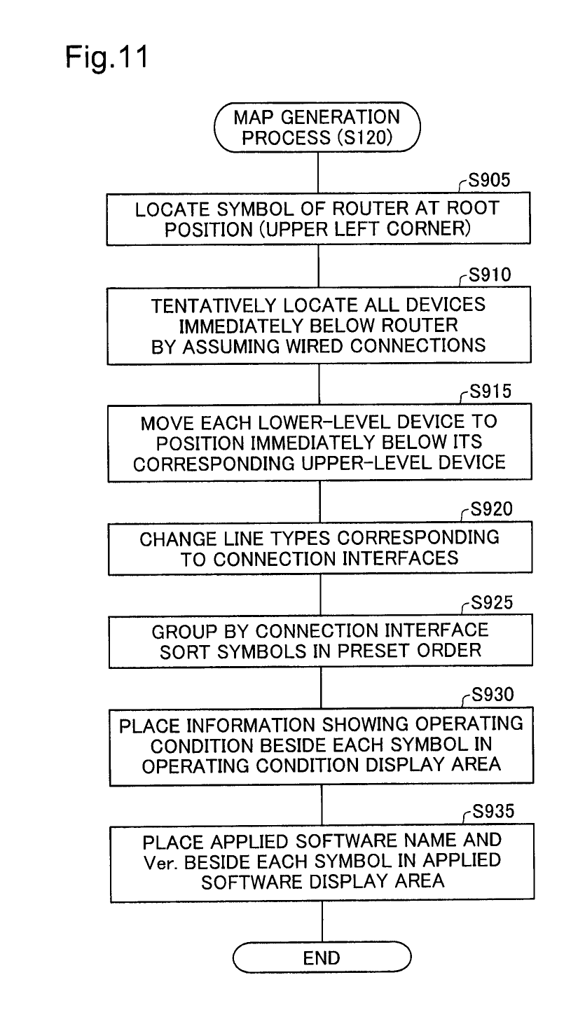

The map generation process to generate the system configuration map m1 shown in FIG. 10 is described below. FIG. 11 is a flowchart showing the detailed procedure of step S120 shown in FIG. 7.

The map generator 11b first locates the symbol of the router 100 at the root position (step S905). The symbol of the router 100 is located at the upper left corner of the window W1 as shown in FIG. 10, and this position corresponds to the root position according to this embodiment. The device name (router) of the router 100 is written inside the symbol.

The map generator 11b tentatively locates all the devices, from which the configuration information has been obtained, immediately below the symbol of the router 100 on the assumption of the wired connection (LAN connection) (step S910). The map generator 11b then refers to the obtained configuration information (lower-level device list) and moves the symbol of each device identified as a lower-level device to the position immediately below the symbol of its corresponding upper-level device (step S915).

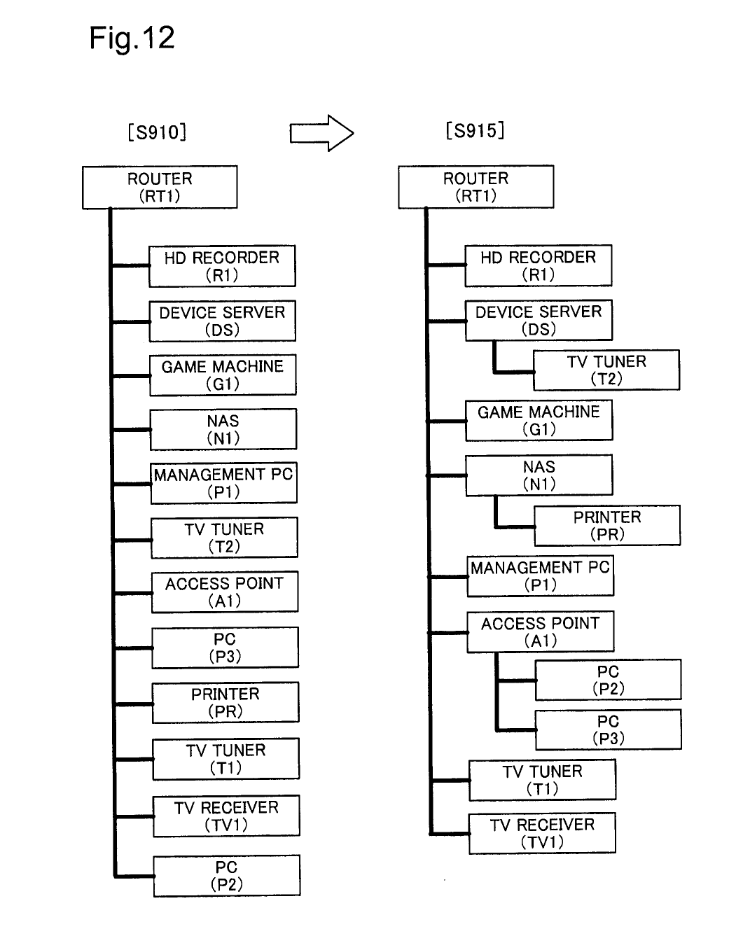

FIG. 12 illustrates the system configuration maps after the processing of step S910 and the processing of step S915 shown in FIG. 11. The left drawing of FIG. 12 shows the system configuration map after the processing of step S910, and the right drawing shows the system configuration map after the processing of step S915. As shown by the left drawing of FIG. 12, the symbols of the respective devices are arrayed in the vertical direction after the processing of step S910. As shown by the right drawing of FIG. 12, the symbols are rearranged to show which of the devices has a lower-level device and what is the lower-level device after the processing of step S915.

Referring back to FIG. 11, after step S915, the map generator 11b changes the line types between the respective devices corresponding to the connection interface types (step S920).

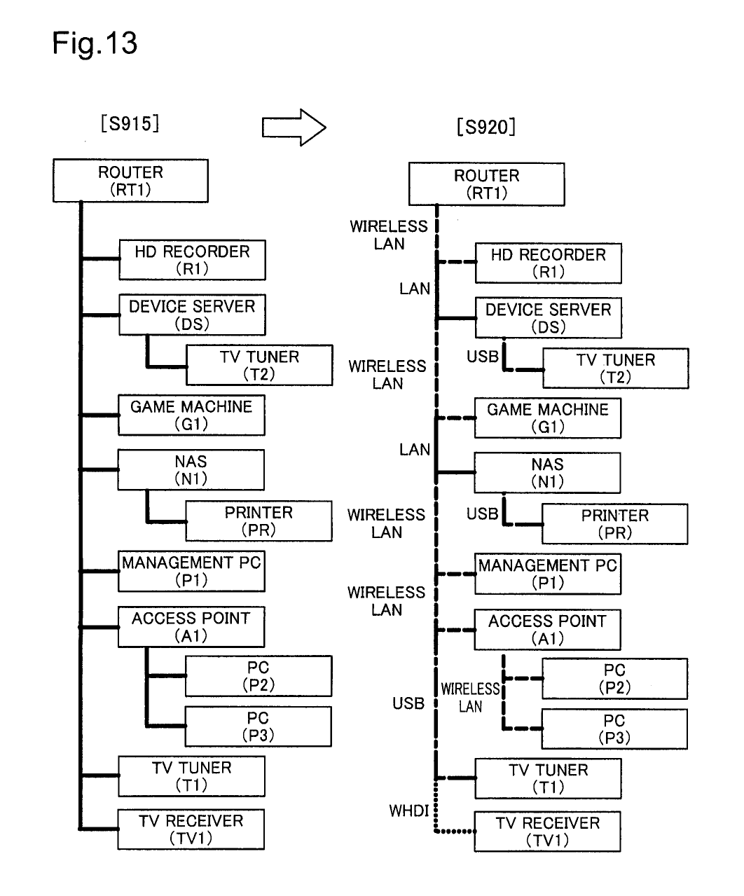

FIG. 13 illustrates the system configuration maps after the processing of step S915 and the processing of step S920 shown in FIG. 11. The left drawing of FIG. 13 shows the system configuration map after the processing of step S915, and the right drawing shows the system configuration map after the processing of step S920. The left drawing of FIG. 13 is identical with the right drawing of FIG. 12. As shown in the right drawing of FIG. 13, the lines connecting the devices are expressed by the different line types corresponding to the different connection interfaces after the processing of step S920.

Referring back to FIG. 11, after step S920, the map generator 11b groups the symbols of the devices by the connection interface with the router 100 while keeping the connection relationships between the devices and their lower-level devices, and sorts (rearranges) the symbols in a preset order (step S925).

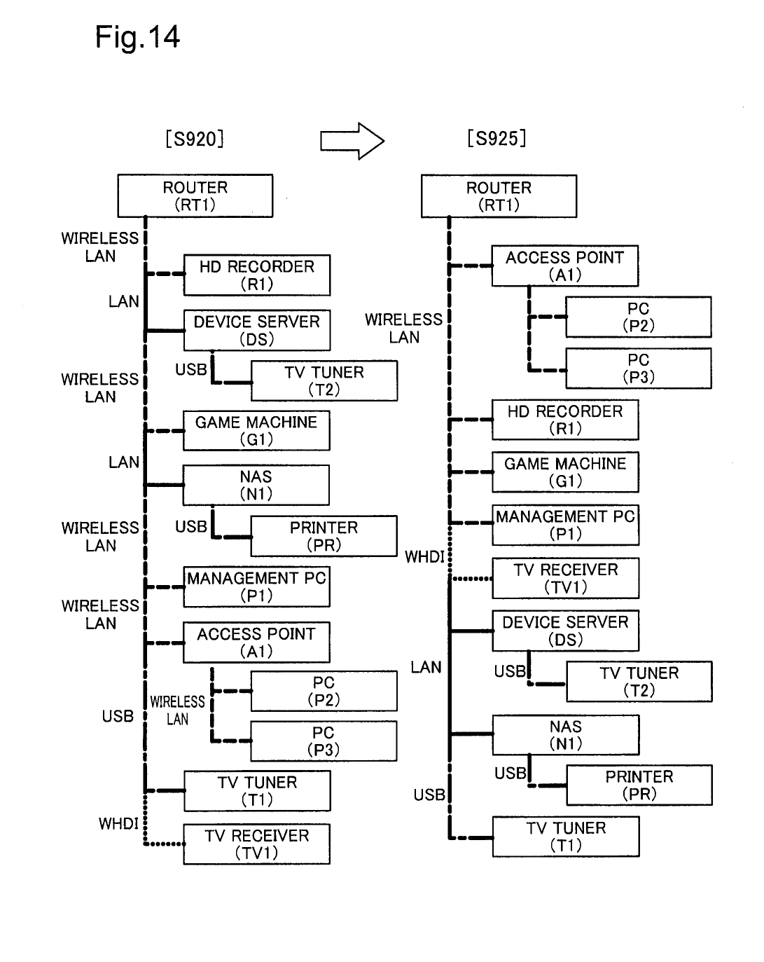

FIG. 14 illustrates the system configuration maps after the processing of step S920 and the processing of step S925 sown in FIG. 11. The left drawing of FIG. 14 shows the system configuration map after the processing of step S920, and the right drawing shows the system configuration map after the processing of step S925. The left drawing of FIG. 14 is identical with the right drawing of FIG. 13. The right drawing of FIG. 14 matches the display in the connection mode display area AR1 of the system configuration map m1 shown in FIG. 10. As shown in the left drawing of FIG. 14 (right drawing of FIG. 13), the devices having different connection interfaces with the router 100 may be arranged adjacent to each other after the processing of step S920. As shown in the right drawing of FIG. 14, however, the devices are grouped by the connection interface with the router 100 after the processing of step S925.

Referring back to FIG. 11, after step S925, the map generator 11b displays the information showing the operating conditions of the respective devices included in the system 500 in the operating condition display area AR2 at the positions corresponding to the symbols representing the respective devices displayed in the connection mode display area AR1. More specifically, the “positions corresponding to the symbols representing the respective devices” indicate the positions besides, i.e., the positions aligned in the horizontal direction with, the symbols of the respective devices displayed in the connection mode display area AR1 (step S930).

After step S930, the map generator 11b displays the software names and the versions of the software applied to the respective devices included in the system 500 in the software information display area AR3 at the positions corresponding to the symbols representing the respective devices displayed in the connection mode display area AR1 (step S935). The map generator 11b generates the system configuration map according to the above procedure (step S120 in FIG. 5).

A6. Software Update Process

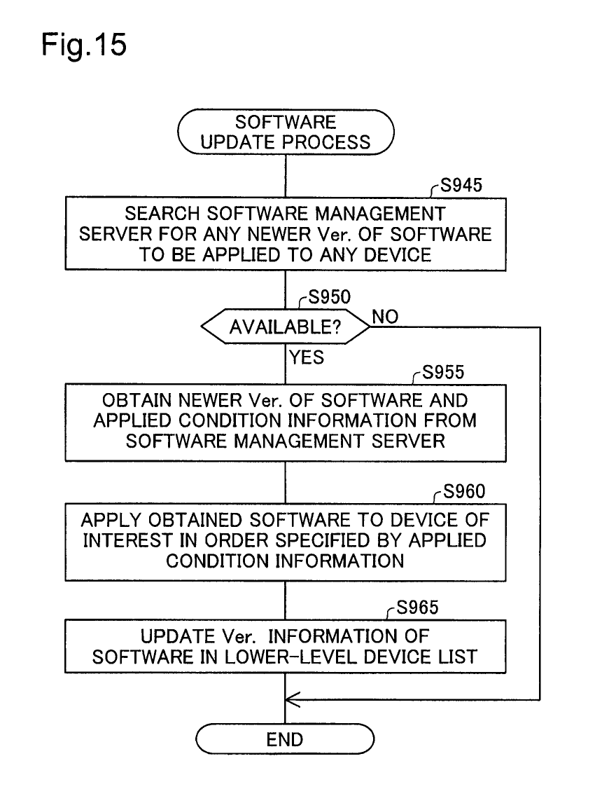

FIG. 15 is a flowchart showing the procedure of software update process performed in the system. In the system 500, the software update process is performed at regular intervals to update the software (firmware and applications) applied to the respective devices.

The update monitor 11d of the management PC 303 searches the software management servers 700 for any newer version of the software to be applied to any of the devices (step S945) and determines whether any newer version of the software is available (step S950). The address information of the respective software management servers 700 is stored in the server address information storage module 14a of the management PC 303 (FIG. 3). The update monitor 11d queries each of the software management servers 700 for the availability of the newer version of the software, based on the address information. The lower-level device list is stored in the configuration information storage module 14b of the management PC 303. The lower-level device list includes the storage of the software names and the version information of the software applied to the respective devices as shown in FIG. 8. The update monitor 11d accordingly queries each of the software management servers 700 for the availability of the newer version of the software, based on these software names and the version information. In each of the software management servers 700, the software supply manager 731 shown in FIG. 5 replies about the availability of the newer version of the software with respect to each software, in response to the query from the management PC 303.

When it is determined that the newer version of the software is available in a software management server 700 (step S950: Yes), the update monitor 11d of the management PC 303 obtains the available newer version of the software and applied condition information from the software management server 700 (step S955). The applied condition information indicates the software name and the version information of any software to be applied prior to application of the downloaded newer version of the software. In response to a request for obtaining the newer version of the software (download request) from the management PC 303, the software supply manager 731 of the software management server 700 refers to the applied condition table TB1 and identifies the software name and the version of the software to be applied first (FIGS. 5 and 6). The software supply manager 731 then sends the applied condition information with the newer version of the software to the management PC 303.

For example, while the software (software name “Sn1”) of the version 2.00 is currently applied to the wireless LAN access point 304, the software Sf1 of the version “3.00” and the software Sf2 of the version “3.10” are stored as the software having the software name “Sn1” in the hard disk 712 of the software management server 700 as shown in FIG. 5. As shown in FIG. 6, whilst there is no software set as the software to be applied first for the software Sf1 (ID:1), the software “ID:1” and the software “ID:3” are set as the software to be applied first for the software Sf2 (ID: 2). The software supply manager 731 of the software management server 700 accordingly sends information indicating the software of the software name “Sn1” and the version “3.00” and information indicating the software of the software name “Sn2” and the version “1.50” as the applied condition information to the management PC 303, while providing the management PC 303 with the software Sf2 (software name “Sn1” and version “3.10”) shown in FIG. 5.

After obtaining the newer version of the software and the applied condition information, the software update controller 11e of the management PC 303 applies the obtained software to the target device in the update order specified by the obtained applied condition information (step S960).

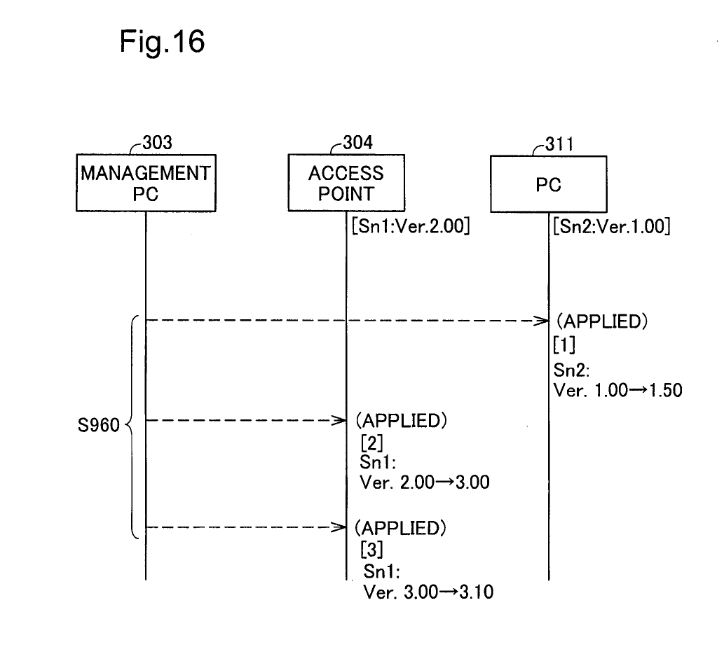

FIG. 16 is a sequence diagram schematically showing an example of applying the newer version of the software. In FIG. 16, the left flow shows the processing flow of the management PC 303, the middle flow shows the processing flow of the wireless LAN access point 304, and the right flow shows the processing flow of the personal computer 311. Prior to start of this sequence diagram, the software (software name “Sn1”) of the version “2.00” is applied to the wireless LAN access point 304, and the software (software name “Sn2”) of the version “1.00” is applied to the personal computer 311.

As shown in FIG. 6, two software of ID=1, 2 are registered as the newer version of the software that has the software name “Sn1” and is newer than the version “2.00” in the applied condition table TB1. These two software are thus obtained at step S955 of FIG. 15. The software of ID=3 is registered as the newer version of the software that has the software name “Sn2” and is newer than the version “1.00” in the applied condition table TB1. This software is thus obtained at step S955 of FIG. 15.

As shown in FIG. 6, the software of ID=1, 3 should be applied prior to the software of ID=2, while the software of ID=4 should be applied prior to the software of ID=3. The software of ID=4 represents the software of the software name “Sn2” and the version “1.00”. This software has already been applied to the personal computer 311. As part of the processing of step S960 in FIG. 15, the software update controller 11e first applies the software of ID=3 to the personal computer 311, in order to update the version of the software from “1.00” to “1.50” ([1] of FIG. 16).

As part of the processing of step S960 in FIG. 15, the software update controller 11e then applies the software of ID=1 to the wireless LAN access point 304, in order to update the version of the software (software name “Sn1”) applied to the wireless LAN access point 304 from “2.00” to “3.00” ([2] of FIG. 16). As part of the processing of step S960, the software update controller 11e subsequently applies the software of ID=2 to the wireless LAN access point 304, in order to update the version of the software (software name “Sn1”) applied to the wireless LAN access point 304 from “3.00” to “3.10” ([3] of FIG. 16). In this manner, the plurality of software to be applied to the personal computer 311 and the wireless LAN access point 304 and the plurality of different versions of the software to be applied to the wireless LAN access point 304 are applied in the order (applied order) set in the applied condition table TB1.

Referring back to FIG. 15, after applying the newer version of the software, the software update controller 11e of the management PC 303 updates the version information of the updated software in the lower-level device list stored in the configuration information storage module 14b (step S965).

In the system 500 described above, the management PC 303 indirectly acquires the configuration information of a target device (for example, TV tuner 341) that is not directly connected with the router 100 via a device (for example, device server 331) directly connected with both the router 100 and the target device. This facilitates management of a plurality of devices connected by not only the connection interfaces for direct connection with the router 100 but various other connection interfaces. The centralized management of the respective devices by the management PC 303 does not require a management device (management software) provided for each connection interface type. This saves the cost for constructing the system 500 and does not require the user to learn how to use a plurality of management devices (management software), thus ensuring easy introduction into the home or small business.

In response to the query for configuration information from the management PC 303, the router 100 creates a lower-level device list including the IP address of each lower-level device and information showing whether each lower-level device has any further lower-level device and sends the created lower-level device list in addition to the own configuration information to the management PC 303. The management PC 303 refers to this lower-level device list to identify each lower-level device and queries each lower-level device for the configuration information of its further lower-level device.

In response to the query for configuration information from the management PC 303, the device that has any lower-level device and is not directly connected with the router 100 obtains the configuration information of the lower-level device, creates a lower-level device list and sends the own configuration information and the created lower-level device list to the management PC 303 (steps S310 to S320). Even when the bus interface is used for the connection interface between the device with any lower-level device and its lower-level device and thereby the management PC 303 can not directly obtain the configuration information of the lower-level device, this enables the configuration information of the lower-level device to be obtained via the device having the lower-level device.

The management PC 303 acquires the software names and the version information of the applied software from the respective devices and unifies the management of the obtained information. The management PC 303 can thus collectively (representatively) queries each of the software management servers 700 for the availability of any newer version of the software. Compared with the configuration that the respective devices individually monitor the availability of any newer version of the software, this configuration advantageously reduces the resources of the respective devices (e.g., CPU and memory) required for monitoring and the network resources (e.g., network bandwidth and delay). The user is not required to check the version of the software currently applied to each of the devices or to download the newer version of the software from each of the software management servers 700. This facilitates updating the software applied to the respective devices.

The software update controller 11e of the management PC 303 obtains the applied condition information with the software from the software management server 700 and applies the plurality of software according to the applied condition (applied order) specified by the applied condition information. The user is thus not required to manually apply the plurality of software by taking into account the applied order of the plurality of software. Each of the software management servers 700 has the applied condition table TB1 for specifying the software to be applied prior to each software of interest. The software management server 700 can thus provide the management PC 303 with the information regarding the software to be applied first (software name and version information).

The management PC 303 queries only the router 100 and each of the devices that is not directly connected with the router 100 and has any lower-level device for configuration information. This advantageously relieves the processing load of the management PC 303, compared with querying all the devices included in the system 500 for configuration information. Especially the router 100 has a number of connection interfaces, so that it is highly probable that the router 100 has already obtained the configuration information of each device connected via some connection interface (for example, USB) by the initialization sequence on the connection to the router 100. Querying the router 100 for the configuration information advantageously shortens the time required for obtaining the configuration information.

The symbols of the respective devices are arranged in the hierarchical manner in the system configuration map m1, so that the user can readily understand the connections of the respective devices. The grouped display of the symbols of the respective devices by the connection interface type with the router 100 enables the user to easily understand how many devices are connected for each connection interface. The symbol of a device having the wireless connection interface with the router 100, which does not allow easy detection of the connection or non-connection of the device with the router 100, is arranged at the position closer to the symbol of the router 100 than the symbol of a device having the wired connection interface with the router 100, so as to clearly differentiate between the connection and non-connection of the device with the router 100. Different line types corresponding to different connection interface types are used for connecting the symbols, so as to clearly differentiate among the connection interface types for the respective devices. Displaying the connection lines between the symbols corresponding to the actual connections between the devices enables the user to readily understand the actual connection configuration.

Arraying the symbols of the respective devices in the vertical direction enables the space for displaying the operating condition of each device to be provided adjacent to the symbol of the device in the horizontal direction. Additionally, displaying the information on the operating condition of each device (symbol or character string) at the position corresponding to the symbol of the device enables the user to understand the operating condition of the device at first sight.

### B. Second Embodiment

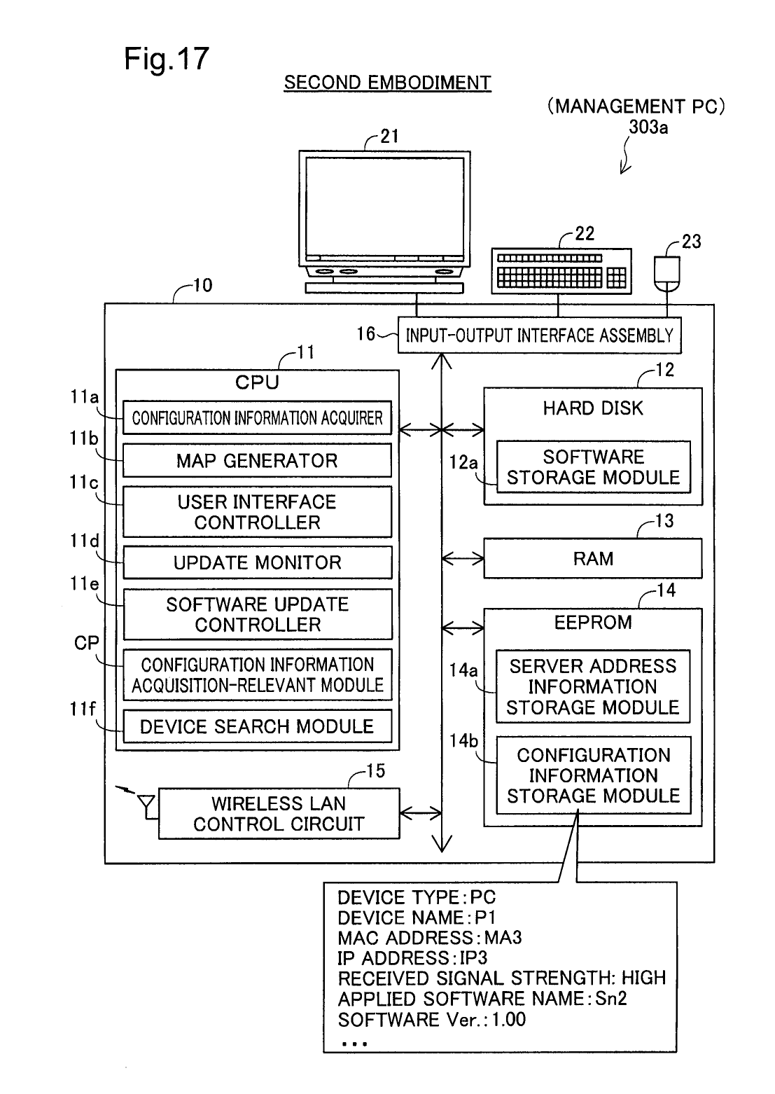

FIG. 17 schematically illustrates the structure of a management PC according to a second embodiment. The management PC 303a of the second embodiment differs from the management PC 303 of the first embodiment shown in FIG. 3 in the additional function as a device search module 11f, but otherwise has the similar structure to that of the management PC 303. According to the first embodiment, the management PC 303 specifies each device, based on the lower-level device list notified by the router 100. According to the second embodiment, on the other hand, the management PC 303a searches for each device. The device structures and the processing flows in the system of the second embodiment other than this device structure and the relevant processing flow are identical with those of the first embodiment.

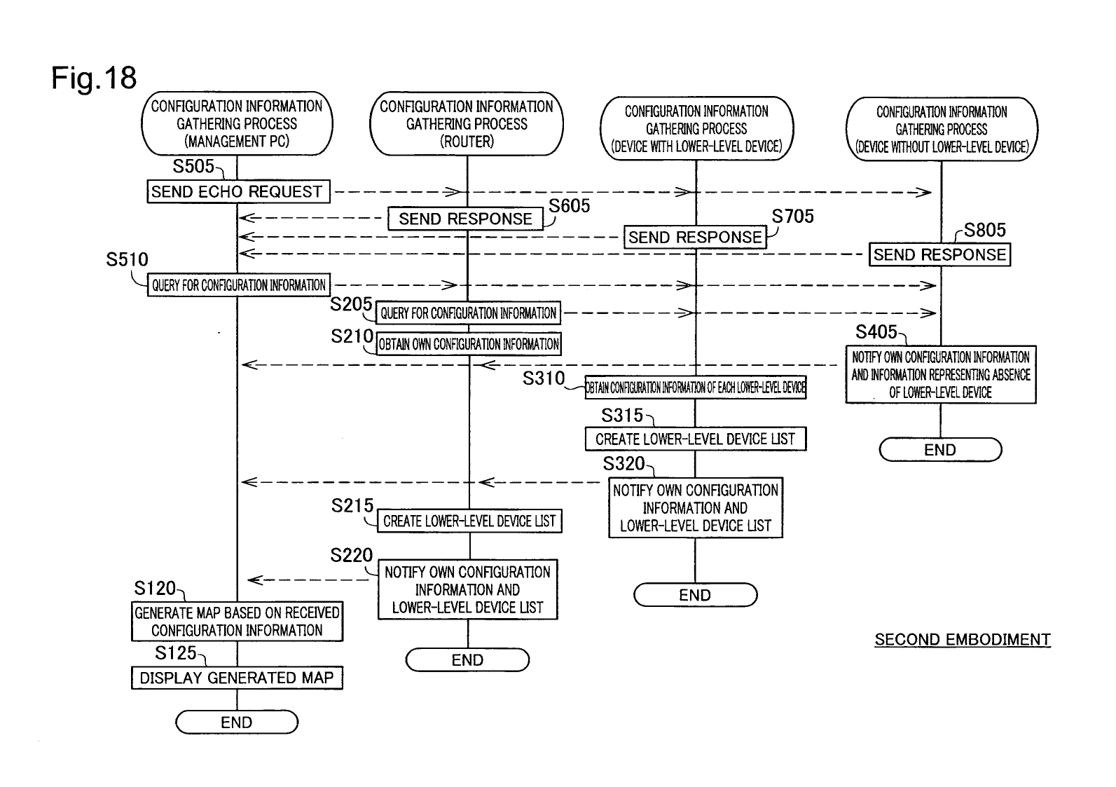

FIG. 18 is a sequence diagram showing a procedure of configuration information gathering process according to the second embodiment. The leftmost flow shows the processing flow of the management PC 303a. The second left flow, the third left flow and the rightmost flow respectively show the processing flow of the router 100, the processing flow of a device with any lower-level device but the router 100 and the processing flow of a device without any lower-level device.

The device search module 11f of the management PC 303a sends an echo request to all the devices included in the system 500 (step S505). The echo request requires only a simple response and checks whether each device is reachable online, based on the response or no response to the echo request. This embodiment uses ICMP (Internet Control Message Protocol) ping (packet internet grouper) as the response request. In this application, one available method may set the IP addresses of the respective devices in the management PC 303a. The method of sending ping is, however, not restricted to the method of setting the IP addresses of the respective devices in the management PC 303a and sending ping to the IP addresses as the destinations but may be the method of setting IP addresses and subnet masks belonging to a network used in the system 500 and sending ping to all possible IP addresses that may be allocated to this network. Another available method may query the router 100 for a network address and send ping to all possible IP addresses that may be allocated to the network.

When receiving the echo request, the wired LAN control circuit 170 of the router 100 sends a response to the management PC 303a (step S605). Similarly, when receiving the echo request, the device with any lower-level device and the device without any lower-level device sends a response to the management PC 303a (step S705 or step S805). When ping is used as the echo request of step S505, only the devices that are capable of interpreting ICMP among the devices included in the system 500 send the response at step S705 or at step S805.

The configuration information acquirer 11a of the management PC 303a queries each of the devices, which have sent a response to the echo request of step S505, for configuration information (step S510).

After sending the response to the management PC 303a (after step S605), the router 100 performs the processing of steps S205, S210, S215 and S220 described above in the first embodiment. After sending the response to the management PC 303a (after step S705), the device with any lower-level device performs the processing of steps S310, S315 and S320 described above. After sending the response to the management PC 303a (after step S805), the device without any lower-level device performs the processing of step S405 described above.

The management PC 303a receives the configuration information or the lower-level device list from each of the devices and performs the processing of steps S120 and S125 described above to display the system configuration map on the display 21.

In the system of the second embodiment described above, the management PC 303a has the similar advantageous effects to those of the management PC 303 of the first embodiment. Additionally, the direct query for configuration information from the management PC 303a to each device enables the configuration information to be obtained from the respective devices except the router 100 even in the case of a failure in the router 100.

### C. Third Embodiment

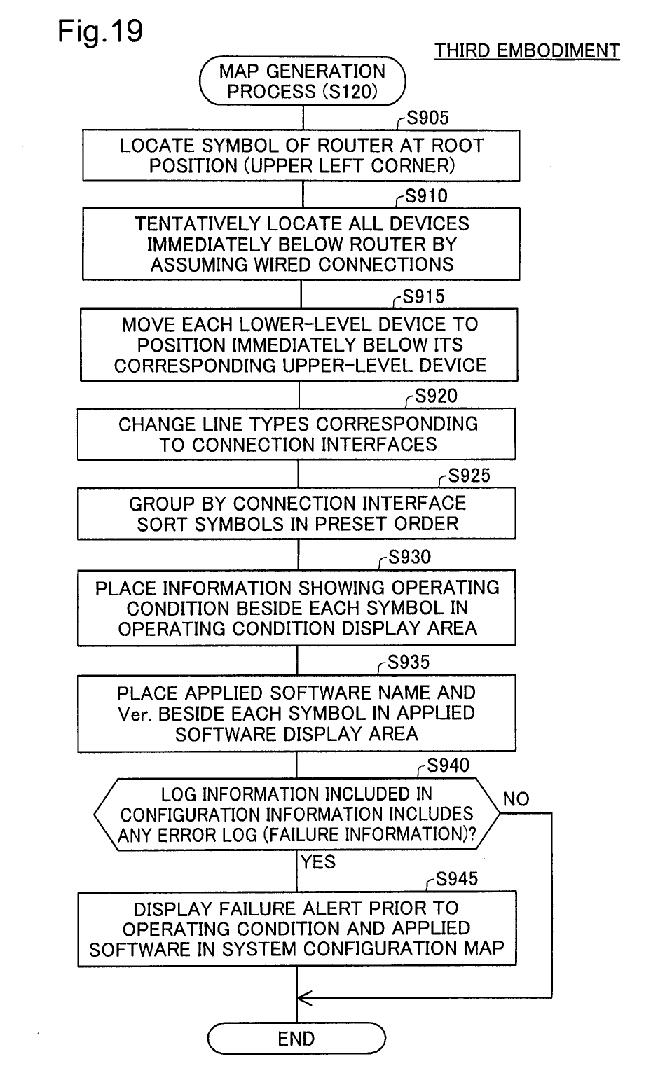

FIG. 19 is a flowchart showing the detailed procedure of the map generation process (step S120) according to a third embodiment. The map generation process of the third embodiment differs from the map generation process of the first embodiment performed by the management PC 303 in that the management PC 303 additionally performs the processing of steps S40 and S945 and that the configuration information includes log information, but otherwise has the similar processing flow to that of the map generation process of the first embodiment performed by the management PC 303. The device structures and the processing flows in the system of the third embodiment other than the structure of the management PC 303 and the map generation process are identical with those of the first embodiment. As the result of the configuration information gathering process, the log information is gathered from the respective devices to the management PC 303. The log information includes information regarding a wide variety of logs, such as system log and error log. The system log includes, for example, various event histories (time of event and result of event), such as a change of the settings in each device or backup. The error log includes, for example, the failure history (information for specifying the time of failure and the location of failure).

According to the map generation process of the third embodiment, as shown in FIG. 19, after step S935, the map generator 11b determines whether the log information included in the obtained configuration information includes any failure information (error log) (step S940). When it is determined that the log information includes any failure information (step S940: Yes), the map generator 11b displays a failure alert in the system configuration map, prior to the operating condition and the software information (software name and version information) (step S945). When it is determined that the log information does not include any failure information (step S940: No), on the other hand, the map generation process is terminated.

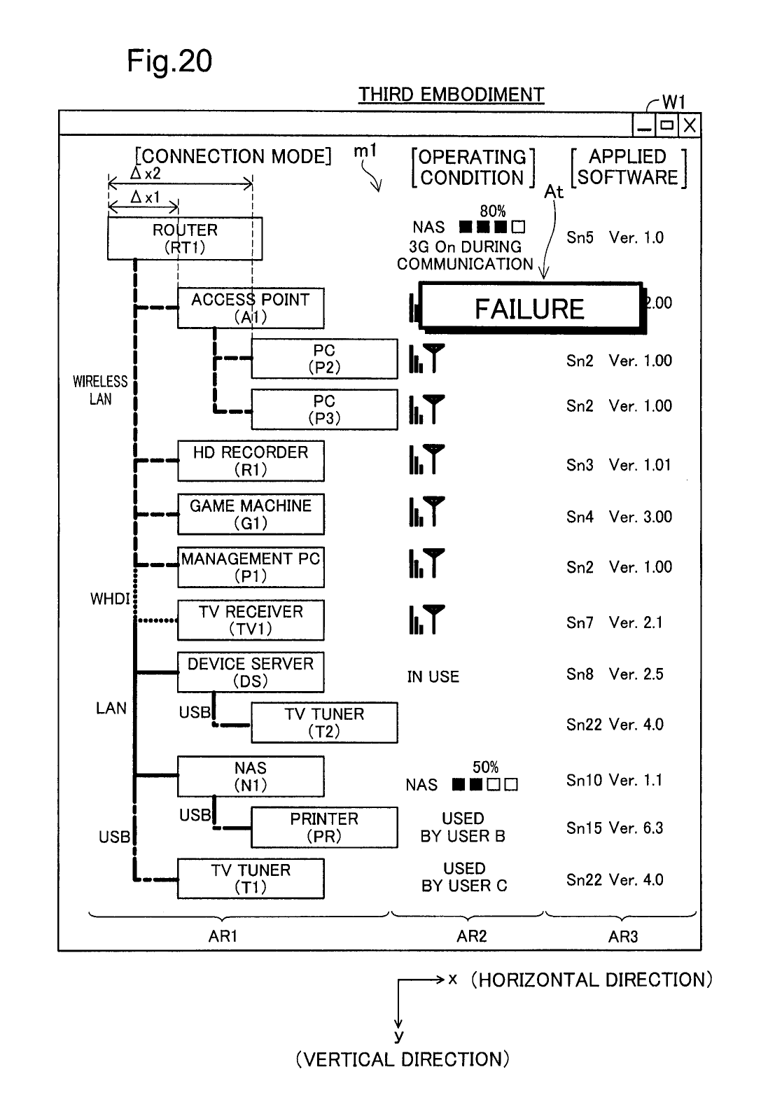

FIG. 20 illustrates one example of the system configuration map when the processing of step S945 is performed. When a failure occurs in the wireless LAN access point 304, the log information included in the configuration information of the wireless access point 304 includes a error log as shown in FIG. 20. In this case, the processing of step S945 is performed, and failure alert At is displayed on the system configuration map m1 as shown in FIG. 20. The failure alert At is displayed at the position corresponding to the symbol of the wireless LAN access point 304 in the system configuration map m1. According to the third embodiment, the failure alert At is displayed prior to the operating condition and the software information by making the failure alert At appear superimposed onto the operating condition displayed in the operating condition display area AR2 and the software information displayed in the software information display area AR3.

According to one embodiment, detailed failure information included in the error log may be displayed on the system configuration map m1 by the user's selection of the failure alert At with the keyboard 22 or the mouse 23.

In the system of the third embodiment described above, the management PC 303 has the similar effects to those of the management PC 303 of the first embodiment. Additionally, the log information is gathered as part of the configuration information from the respective devices to the management PC 303, so that the management PC 303 can display failure alert in the system configuration map m1 as appropriate. Displaying the failure alert prior to the operating condition and the software information prevents the user (system administrator) from overlooking the occurrence of failure. Since the log information of all the devices including the device with a failure is gathered in the management PC 303, the user is not required to newly obtain the log information from the device with failure and any devices connected with the device with failure, for the purpose of failure isolation. The user (system administrator) can check the gathered information in the management PC 303 in a unified manner, so as to identify the location of failure and the cause of failure within a short time period.

### D. Fourth Embodiment

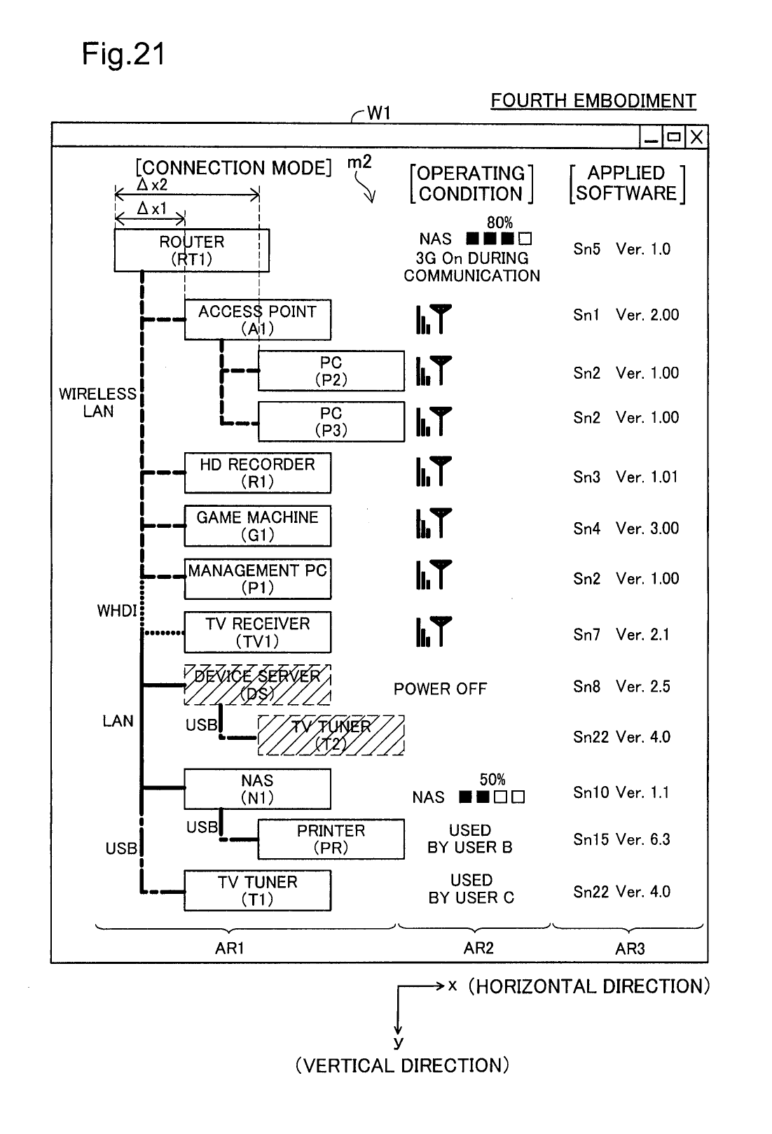

FIG. 21 illustrates a system configuration map displayed on the display according to a fourth embodiment. The system of the fourth embodiment adopts a different display format of the system configuration map from that of the system 500 of the first embodiment, but otherwise has the same configuration as that of the first embodiment. The system of the first embodiment displays the operating conditions of the respective devices included in the system 500 in the operating condition display area AR2; for example, when a device is powered off, information representing the power-off state is displayed in the form of a character string in the operating condition display area AR2.

The system of the fourth embodiment, on the other hand, changes the display of the symbol of each device according to a change in its operating condition, while displaying the operating condition of the device in the operating condition display area AR2. More specifically, for example, when the device server 331 is powered off, the system of the third embodiment grays out the symbol of the device server 331, while displaying a character string “power off” in the operating condition display area AR2 of a system configuration map m2 as shown in FIG. 21. The symbol of the TV tuner 341 connected with the device server 331 is simultaneously grayed out. The symbol of the TV tuner 341 is also grayed out, because the management PC 303 is not informed of the operating condition of the TV tuner 341, which is the lower-level device of the device server 331, after the power-off of the device server 331.

When the device is powered on again, it is preferable to return the grayed-out symbol of the device to its original display.

In the system of the fourth embodiment described above, the management PC has the similar advantageous effects to those of the management PC 303 of the first embodiment. The additional change in display of the symbol of each device according to a change in its operating condition further facilitates the user's understanding of the operating conditions of the respective devices.

### E. Fifth Embodiment

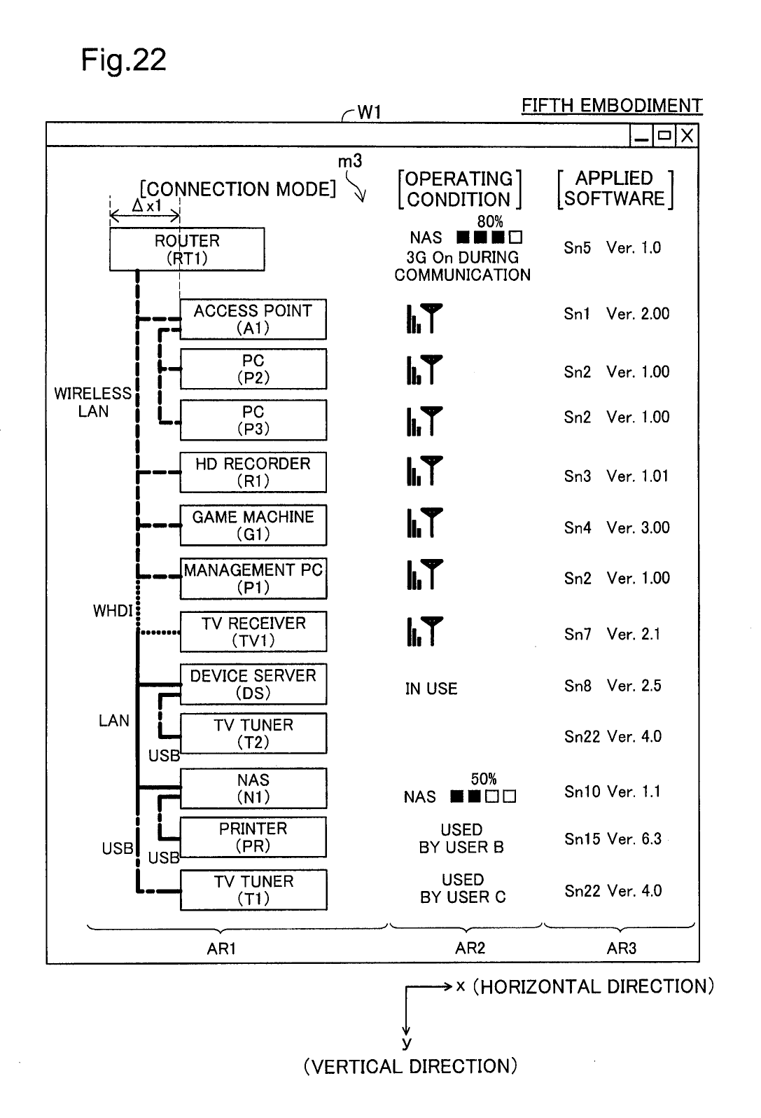

FIG. 22 illustrates a system configuration map displayed on the display according to a fifth embodiment. The system of the fifth embodiment adopts a different display format of the system configuration map from that of the system 500 of the first embodiment, but otherwise has the same configuration as that of the first embodiment. According to the first embodiment, the symbols of the respective devices including the router 100 are arranged in the hierarchical manner in the system configuration map m1 displayed on the display 21. According to the fifth embodiment, on the other hand, the symbols of the respective devices other than the router 100 are arranged on an identical hierarchical level.

More specifically, in a system configuration map m3 of the fifth embodiment shown in FIG. 22, the symbols of the respective devices other than the router 100 are all located at offset Δx1 right in the x direction (horizontal direction) from the symbol of the router 100 to be arranged on the same hierarchical level. Like the first embodiment, the connection lines between the symbols are displayed corresponding to the actual connections between the devices, so that the user can readily understand the actual connection configuration. According to this embodiment, the symbol (for example, symbol A1) of the device (first device) directly connected with the router 100 is located at the position having a shorter distance in the y direction (vertical direction) from the symbol of the router 100 than the symbol (for example, symbol P2) of the device (second device) that is connected with the first device and has a greater number of devices intervening before the router 100. The symbol of the first device is accordingly located at the position closer to the symbol of the router 100 than the symbol of the second device. This enables the user to sensuously and easily understand the connections between the respective devices.

In the system of the fifth embodiment described above, the management PC has the similar advantageous effects to those of the management PC 303 of the first embodiment.

### F. Modifications

The disclosure is not limited to the above embodiments, but a multiplicity of variants and modifications may be made to the embodiments without departing from the scope of the disclosure. Some examples of possible modifications are described below.

F1. Modification 1

The method of setting the IP addresses of the respective devices in advance in the management PC 303a or the method of determining all the possible IP addresses that may be allocated to a network in the system 500 as the destination IP addresses is adopted to determine the IP addresses of the destinations of the echo request, such as ping according to the second embodiment, but the disclosure is not limited to such methods. The router 100 also functions as a DHCP server and may thus query the router 100 for IP addresses allocated to the respective devices as DHCP clients and determine the IP addresses obtained as the reply to the query as the destination IP addresses of the echo request. In an application including a separate DHCP server from the router 100, the method may query the DHCP server, instead of the router 100, for the allocated IP addresses.

F2. Modification 2

According to the first embodiment, the management PC 303 (configuration information acquirer 11a) queries each lower-level device of the router having any lower-level device for configuration information. According to the second embodiment, the management PC 303a queries all the devices responding to the echo request for configuration information. The disclosure is, however, not limited to these methodologies. According to another methodology, the management PC may query the router 100 for configuration information, and the router 100 may obtain configuration information of all the devices and collectively notify the management PC of the obtained configuration information. More specifically, the router 100 may perform the processing of steps S110 and S115 described in the first embodiment. Similarly, the router 100 may perform the processing of steps S505 and S510 described in the second embodiment.

F3. Modification 3

The management PC 303 (configuration information acquirer 11a) checks whether each device has any lower-level device (step S110), based on the settings in the lower-level device presence/absence field of the lower-level device list according to the first embodiment, but the disclosure is not limited to this methodology. According to another methodology, device types that are generally not expected to have any lower-level device may be set in advance in the management PC 303, and the above checking may be based on the comparison between the preset device types and the settings in the device type field of the lower-level device list. The device types that are not expected to have any lower-level device may include, for example, “hard disk recorder”, “TV receiver” and “printer”. This methodology does not require acquisition of the information on the presence/absence of any lower-level device from the respective devices, thus reliving the processing load and reducing the data size of the lower-level device list.

In the above embodiment, the “configuration information” includes the information regarding the device type of each device. The “configuration information” may alternatively not include the information regarding the device type of each device. According to this modification, for example, the system configuration map (FIG. 10) displayed on the display as the result of the map generation process may not include the display of the device type. In another example, the management PC 303 as the management device may store the information regarding the device type of each device, and the displayed system configuration map may include the information regarding the device type of each device, based on the stored information.

F4. Modification 4

In the embodiments described above, part of the devices connected with the router 100 may be omitted. A plurality of devices are connected to the router 100 in the above embodiment, but only one device may be connected to the router 100. Any lower-level device of the devices other than the router 100 (two personal computers 311 and 312, TV tuner 341 and printer 342 shown in FIG. 1) does not have its lower-level device in the above embodiments, but may further have its lower-level device. The plurality of software management servers 700 are provided individually for the respective hardware manufacturers in the above embodiments, but a plurality of servers may be provided individually for respective software manufacturers or individually for respective areas in each manufacturer. Only one software management server may be provided, instead of the plurality of software management servers 700.

The connection interfaces between the respective devices adopted in the above embodiment include the wired LAN interface (LAN interface conforming to the IEEE802.3 standard), the wireless LAN interface (LAN interface conforming to the IEEE802.11b/g standard), the WHDI and the USB2.0, but the disclosure is not limited to these interfaces.

Any arbitrary interfaces may be adopted for the network interfaces; for example, an interface conforming to the IEEE802.3z or IEEE802.3ab standard as the wired LAN interface and an interface conforming to the IEEE802.11a or IEEE802.11n standard as the wireless LAN interface. Any arbitrary interfaces may also be adopted for the bus interfaces; for example, an interface conforming to the USB1.1 or USB3.0 protocol as the USB interface, a serial transfer interface, such as an interface conforming to the IEEE1394 or PCI Express (PCIe) standard, a video/sound input/output interface, such as an HDMI (High-Definition Multimedia Interface) or WirelessHD (WiHD) interface, and a near field communication interface, such as a Zigbee, Bluetooth or IrDA interface. In an application adopting a device of collecting pulse data sent by Zigbee from a small pulse monitor in the system 500, the pulse data may be displayed as information on the operating condition of the pulse monitor in the system configuration map.

F5. Modification 5

The information showing the operating conditions of the respective devices displayed in the system configuration map in the above embodiments includes, for example, the use capacity of the hard disk, the received signal strength and the name of the user currently using the device as shown in FIG. 8, but the disclosure is not restricted to such information. For example, the information may be the remaining ink level or the total number of printed pages with respect to the printer. The device name is displayed as the information identifying each device in the system configuration map, but the disclosure is not limited to such information. Any arbitrary information identifying each device, such as an IP address or a MAC address, may be displayed, in place of or in addition to the device name, in the system configuration map.

F6. Modification 6

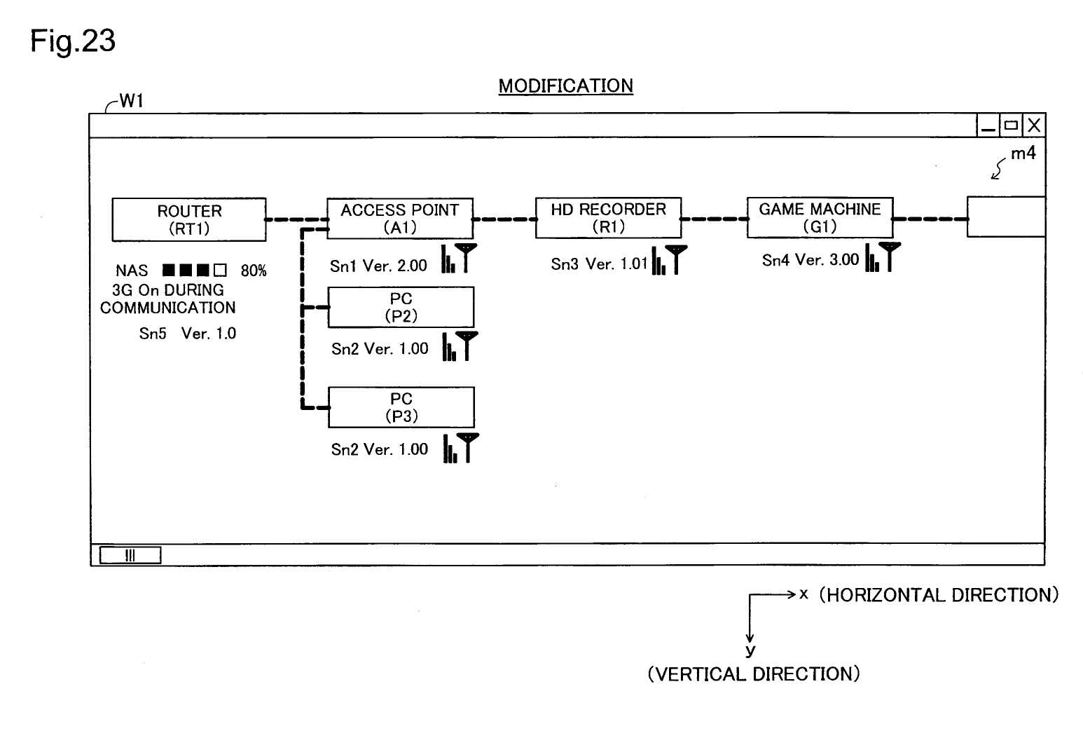

The display format of the system configuration map is not limited to those shown in the above embodiments, but the disclosure may adopt any other suitable display format. FIG. 23 illustrates an exemplary system configuration map displayed on the display of the management PC according to one modification. A system configuration map m4 shown in FIG. 23 differs from the system configuration map m1 shown in FIG. 10 in that the symbols of the respective devices are arrayed in the x direction (horizontal direction) from the router 100 as the starting point, that the symbol of a lower-level device of a target device is located below the symbol of the target device in the vertical direction and that the information showing the operating condition of each device and the information regarding the applied software (software name and software version) are displayed below the symbol of the device in the vertical direction, but otherwise has the similar structure to that of the system configuration map m1. Although only part of the symbols displayed in the window W1 are shown in FIG. 23, the whole system configuration map m4 is made visible by scrolling the window W1 rightward. This display format according to the modification also clarifies the hierarchical structure of the respective devices and has the other similar advantageous effects to those of the first embodiment. In general, the apparatus of the disclosure may have the display unit configured to array devices directly connected with the router 100 by wireless connection or by wired connection in a predetermined direction from the router 100 as the starting point. According to this modification, the symbol (for example, symbol A1) of the device (first device) directly connected with the router 100 is located at the position having a shorter distance in the y direction (vertical direction) from the symbol of the router 100 than the symbol (for example, symbol P2) of the device (second device) that is connected with the first device and has a greater number of devices intervening before the router 100. The symbol of the first device is accordingly located at the position closer to the symbol of the router 100 than the symbol of the second device. This enables the user to sensuously and easily understand the connections between the respective devices. In any of the above embodiments and modifications, as long as the symbol (for example, symbol A1) of the device (first device) directly connected with the router 100 is located at the position having a shorter distance in at least a predetermined direction from the symbol of the router 100 than the symbol (for example, symbol P2) of the device (second device) that is connected with the first device and has a greater number of devices intervening before the router 100, the symbols may have any positional relationship in another direction. For example, in the system configuration map m1 shown in FIG. 10, the symbol of the first device (for example, symbol A1) is located on the left of (i.e., at the position closer to the symbol of the router 100 than) the symbol of the second device (for example, symbol P2) in the x direction, so that the symbol of the second embodiment may be located above (i.e., at the position closer to the symbol of the router 100 than) the symbol of the first device in the y direction.

The symbols of the devices having the wireless connection interface with the router 100 are located at the position closer to the symbol of the router 100 in the y direction than the symbols of the devices having the wired connection interface with the router 100 in the system configuration map according to the above embodiments, but the disclosure is not limited to this arrangement. For example, the symbols of the devices having the wired connection interface with the router 100 may be located at the position closer to the symbol of the router 100 in the y direction than the symbols of the devices having the wireless connection interface with the router 100. In another example, the symbols of the devices with any lower-level device may be located at the position closer to the symbol of the router 100 in the y direction than the symbols of the devices without any lower-level device. This arrangement clearly differentiates the devices with any lower-level device.

In the above embodiments, the symbols of the respective devices are arranged at the positions of different distances in the y-axis direction from the symbol of the router 100 as the gateway device in the system configuration map (FIG. 10). The disclosure is, however, not limited to this arrangement. For example, the symbols of the respective devices may be arranged radially at the positions of different distances in the radial direction from the symbol of the gateway device in the system configuration map. In this arrangement, it is preferable to locate the symbol of the first device at the position closer to the symbol of the gateway device, compared with the symbol of the second device having a greater number of devices intervening before the gateway device than the first device. In general, the symbol of the first device is arranged at the position closer to the symbol of the gateway device in a predetermined direction than the symbol of the second device. In an application having a plurality of sets of the first device and the second device, the respective sets may be arranged in different directions.

The symbol of a device is grayed out to indicate the power-off state of the device according to the fourth embodiment, but another suitable display format may be adopted to indicate a change in operating condition of the device. For example, the shape of the symbol may be changed according to a change in operating condition (for example, rectangle in the normal working state and triangle in the power-off state), or the symbol may be shaded or non-shaded with a change in operating condition (for example, shaded in the power-on state and non-shaded in the power-off state). In place of or in addition to the symbol of each device, the display format of the connection line between the symbols of the devices may be changed according to a change in operating condition. Specifically, for example, the connection line for a device in the power-off state may be displayed with the lower saturation than that of the connection line for the same device in the power-on state. In another example, the lighted (normal display format) connection line in the power-on state may be flashed in the power-off state.

The information showing the operating condition of each device and the information regarding the software are displayed together with the symbol of the device in the system configuration map according to the above embodiments, but the display of at least one of such information may be omitted. The device type and the device name of each device are shown inside the symbol of each device in the system configuration map according to the above embodiments, but may alternatively be shown outside the symbol of each device. In the latter case, displaying the device type and the device name of each device in correlation to the symbol of the device allows identification of the device in the system configuration map. Instead of both the device type and the device name of each device, only one of the device type and the device name may be displayed for identification of the device.

F7. Modification 7

The system configuration map is displayed on the display 21 of the management PC 303 or 303a according to the above embodiments, but the disclosure is not limited to this display 21. For example, the system configuration map may be displayed on a display of either of the two personal computers 311 and 312. In another example, the system configuration map may be displayed on the TV receiver 321. In an application of the router 100 having a display device, such as a liquid crystal display, the system configuration map may be displayed on the display device. Displaying the system configuration map on the TV receiver 321 allows enlarged display of the system configuration map. Displaying the system configuration map on the display device of the router enables the connection configuration of the respective deices to be readily checked at work in the router 100 (for example, insertion or removal of a cable).

The functional blocks of gathering the configuration information and generating and displaying the system configuration map are implemented by the management PC 303 or 303a according to the above embodiments, but the disclosure is not limited to this implementation. For example, the management PC 303 may be omitted, and the router 100 may serve as the functional blocks to gather the configuration information and generate and display the system configuration map. In this application, the router 100 may be structured to have the functional blocks of the management PC 303 or the management PC 303a. In an application of the system including a different router separate from the router 100, this different router may be structured to have the functional blocks of the management PC 303 or 303a.

F8. Modification 8

All the devices directly connected with the router 100 by wireless connection or by wired connection have the configuration information acquisition-relevant module CP according to the above embodiments, but some of such devices may be structured without the configuration information acquisition-relevant module CP. In the latter case, the device without the configuration information acquisition-relevant module CP does not perform the processing of either step S305 or step S405, so that the router 100 does not add this device to its lower-level device list. In the system of the second embodiment, however, the device without the configuration information acquisition-relevant module CP adopting TCP/IP as the communication protocol can send a response to the echo request (ping), so that the management PC 303a can recognize the presence of the device. In this case, the symbol of the device with its IP address instead of the device name may be displayed immediately below the symbol of the router 100 in the system configuration map. The user may be allowed to add the device type and the device name of the device obtained elsewhere to the displayed symbol of the device. The user may also be allowed to move the symbol of the device to any adequate location in the system configuration map. These variations enable the management PC 303 or the management PC 303a to readily manage even the devices without the configuration information acquisition-relevant module CP.

Each device creates and sends its lower-level device list as the reply to the query from the router 100 or from the management PC 303 or 303a according to the above embodiments, but the disclosure is not limited to this methodology. For example, the wireless LAN access point may send its own wireless LAN association list (enumeration of MAC addresses of the connected devices), instead of the lower-level device list, to the router 100 or to the management PC 303 or 303a. In this application, the router 100 or the management PC 303 or 303a can obtain at least part of the configuration information of each device, based on the MAC address of the device included in the obtained association list. More specifically, the router 100 or the management PC 303 or 303a may adopt RARP (Reverse Address Resolution Protocol) to obtain the IP address of each device, based on the MAC address of the device included in the obtained association list.

According to another modification, each device adopting the network interface for the connection interface to its lower-level device may send address information (for example, MAC address, IP address or subnet mask) of its lower-level device, instead of the lower-level device list, to the router 100 or to the management PC 303 or 303a, while each device adopting the bus interface for the connection interface to its lower-level device may send the lower-level devise list. The management device informed of the address information can directly obtain the configuration information via the network from the lower-level device connected by the network interface. The management device cannot, however, directly obtain the configuration information via the network from the lower-level device connected by the bus interface. Receiving the lower-level device list output from the device adopting the bus interface enables the management device to obtain at least the information recorded in the lower-level device list with respect to the lower-level device.

F9. Modification 9

The configuration information gathering process is performed at regular intervals after the start-up of the management PC 303 or 303a according to the above embodiments, but the disclosure is not limited to this methodology. For example, the configuration information gathering process may be performed automatically only at the start-up of the management PC 303 or 303a and may be performed subsequently in response to the user's execution instruction given to the management PC 303 or 303a. According to another modification, the configuration information gathering process may be triggered by a change of the configuration information in any of the devices. Similarly, the software update process may be performed in response to the user's execution instruction, instead of being performed at regular intervals.

F10. Modification 10

The echo request sent by the device search module 11d is ping according to the second embodiment, but the disclosure is not limited to this methodology. For example, specific data set in advance between the configuration information acquisition-relevant modules CP may be exchanged for the echo request and its response.

F11. Modification 11

According to the second embodiment, when the router 100 fails to respond to the echo request, for example, due to a failure or a trouble, the system configuration map cannot be generated because of the failed first operation step (step S905) of the map generation process shown in FIG. 11. In this case, a preset symbol showing the root may be located at the root position, instead of the symbol of the router 100 at step S905.

The symbol of the router 100 is located at the root position in the system configuration map according to the above embodiments, but the disclosure is not limited to this symbol. For example, the symbol of a device set as a default gateway in the management PC 303 or 303a may be located at the root position. When no default gateway is set in the management PC 303 or 303a, a dummy symbol may tentatively be located at the root position.

F12. Modification 12

The devices connected by a wired LAN or by a wireless LAN are connected directly according to the above embodiments, but the disclosure is not limited to this connection configuration. A device relaying layer 2 frames may intervene between the devices, and the devices may be connected indirectly via this device.

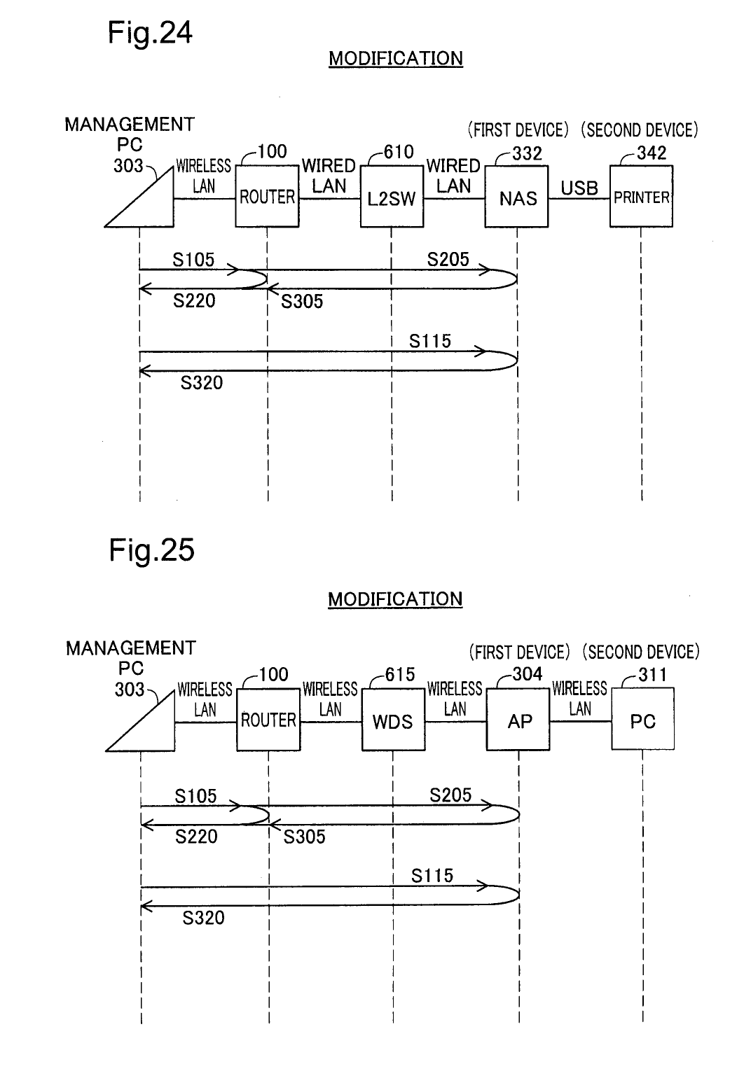

FIG. 24 schematically illustrates one example of the system connection configuration according to one modification. Only the connections between the router 100, the NAS 332 and the printer 342 are shown in FIG. 24, while the connections between the other devices shown in FIG. 1 are omitted. As shown in FIG. 24, a layer 2 switch 610 may intervene between the router 100 and the NAS 332. According to this connection configuration, the packets involved in the query for configuration information output from the router 100 (step S205) and its response (step S305) and the packets involved in the query for configuration information output from the management PC 303 (step S115) and its response (step S320) in the first embodiment do not terminate at the layer 2 switch 610 but reach the destination device (NAS 332, wireless LAN access point 304, router 100 or the management PC 303). The system configuration map displayed on the management PC 303 according to the connection modification of FIG. 24 is identical with the system configuration map m1 of the first embodiment shown in FIG. 10. In other words, the system configuration map does not include the display of a symbol representing the layer 2 switch 610. The layer 2 switch 610 is used for one-to-one connection between the router 100 and the NAS 332 in the connection configuration shown in FIG. 24, but may be connected with another device (for example, device server 331) in addition to the router 100 and the NAS 332 for one-to-n connection between the devices.

FIG. 25 schematically illustrates another example of the system connection configuration according to another modification. Only the connections between the router 100, the wireless LAN access point 304 and the personal computer 311 are shown in FIG. 25, while the connections between the other devices shown in FIG. 1 are omitted. As shown in FIG. 25, a WDS (Wireless Distribution System) device 615 may intervene between the router 100 and the wireless LAN access point 304. The WDS device 615 serves for layer-2 relay of communication between wireless LAN access points. According to this connection configuration, the packets involved in the query for configuration information output from the router 100 (step S205) and its response (step S305) and the packets involved in the query for configuration information output from the management PC 303 (step S115) and its response (step S320) in the first embodiment do not terminate at the WDS device 615 but reach the destination device (wireless LAN access point 304, router 100 or the management PC 303).

The system configuration map displayed on the management PC 303 according to the connection modification of FIG. 25 is identical with the system configuration map m1 of the first embodiment shown in FIG. 10. In other words, the system configuration map does not include the display of a symbol representing the WDS device 615. The WDS device 615 is used for one-to-one connection between the router 100 and the wireless LAN access point 304 in the connection configuration shown in FIG. 25, but may be connected with another device (for example, another access point) in addition to the router 100 and the wireless LAN access point 304 for one-to-n connection between the devices. The layer 2 frame relay device (layer 2 switch or WDS device) may not be located between the router 100 and another device but may be located between devices other than the router 100.

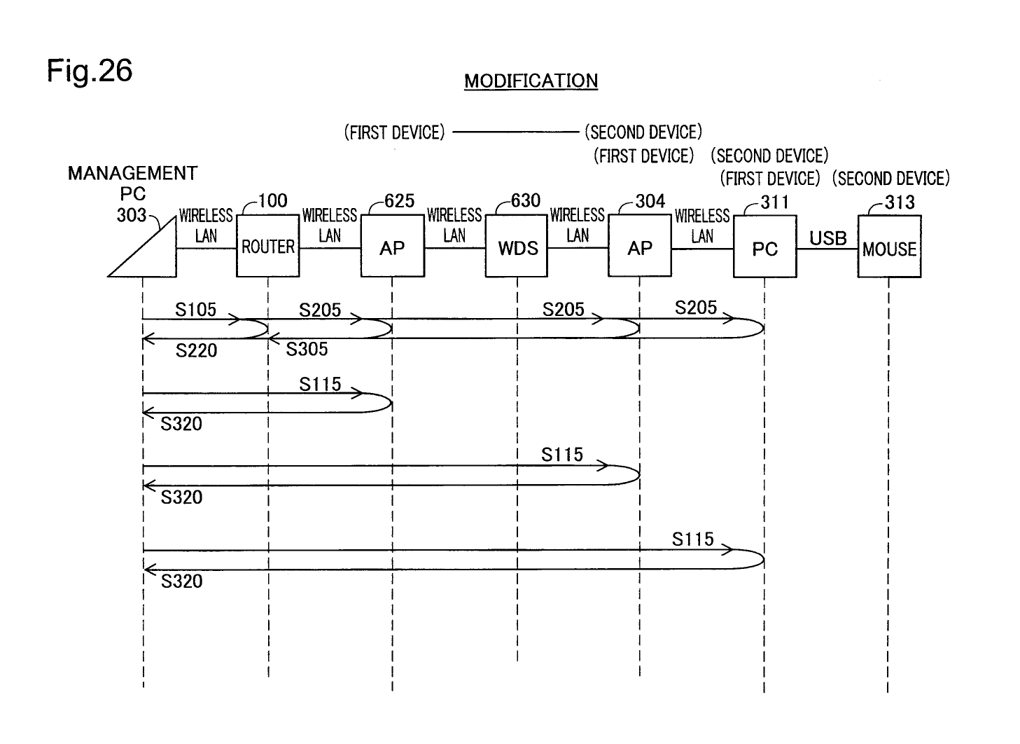

FIG. 26 schematically illustrates another example of the system connection configuration according to another modification. Only the connections between the router 100, the wireless LAN access point 304, the personal computer 311 and the mouse 313 are shown in FIG. 26, while the connections between the other devices shown in FIG. 1 are omitted. The connection configuration shown in FIG. 26 differs from the connection configuration shown in FIG. 9 in addition of a wireless LAN access point 625 and a WDS device 630 between the router 100 and the wireless LAN access point 304, but otherwise has the similar configuration to that shown in FIG. 9. The wireless LAN access point 625 has the same functions as those of the wireless LAN access point 304. The WDS device 630 connects the two wireless LAN access points 304 and 625. According to this connection configuration, the packets involved in the query for configuration information output from the router 100 (step S205) and its response (step S305) and the packets involved in the query for configuration information output from the management PC 303 (step S115) and its response (step S320) in the first embodiment do not terminate at the WDS device 625 but reach the destination device (wireless LAN access point 304, personal computer 311, router 100 or the management PC 303).

In the system configuration shown in FIG. 26, in the pair of the wireless LAN access point 625 and the wireless LAN access point 304, the wireless LAN access pint 625 corresponds to the first device, while the wireless LAN access point 304 corresponds to the second device. In the pair of the wireless LAN access point 304 and the personal computer 311, the wireless LAN access point 304 corresponds to the first device, while the personal computer 311 corresponds to the second device. In the pair of the personal computer 311 and the mouse 313, the personal computer 311 corresponds to the first device, while the mouse 313 corresponds to the second device. The system configuration map displayed on the management PC 303 according to the connection modification of FIG. 26 is different from the system configuration map m1 of the first embodiment shown in FIG. 10. More specifically, the differences from the system configuration map m1 include the presence of a symbol representing the wireless LAN access point 625 between the symbols of the router 100 and the wireless LAN access point 304, the connections between these symbols by connection lines corresponding to the wireless LAN interface, the presence of a symbol representing the mouse 313 under the symbol of the personal computer 311 and the connection between these symbols by a connection line corresponding to the USB interface.

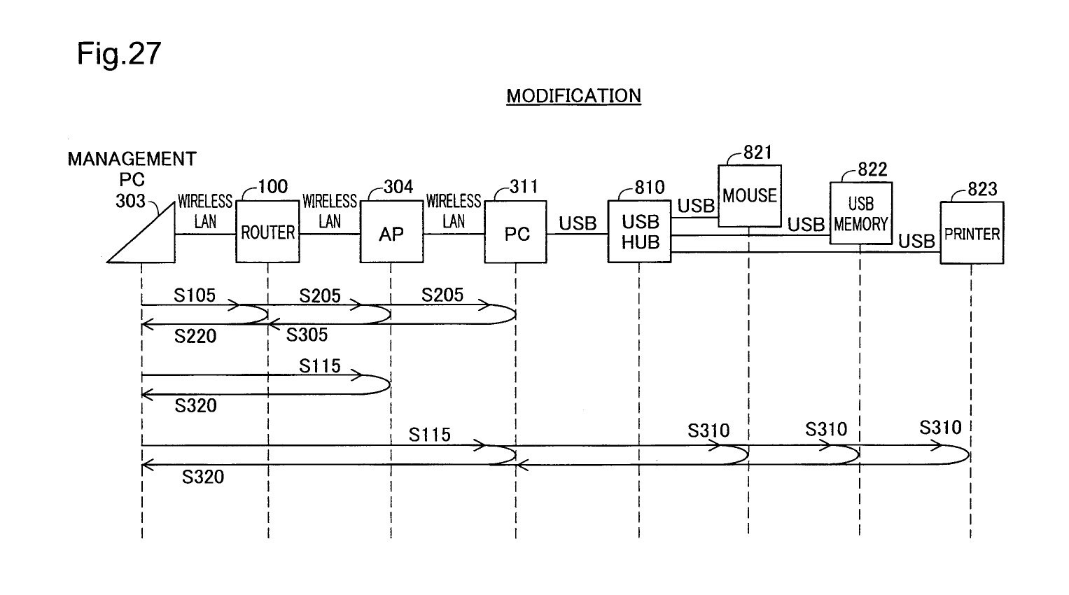

FIG. 27 schematically illustrates another example of the system connection configuration according to another modification. Like the connection configuration of FIG. 25, only the connections between the router 100, the wireless LAN access point 304 and the personal computer 311 are shown in FIG. 27, while the connections between the other devices shown in FIG. 1 are omitted. As shown in FIG. 27, unlike the first embodiment, a USB hub 810 is connected with the personal computer 311. The USB hub 810 has a plurality of ports and is connected with the personal computer 311, a mouse 821, a USB memory 822 and a printer 823 at these ports. The devices connected with the USB hub 810 adopt the USB interface. When the configuration information gathering process of FIG. 7 is performed in this connection configuration, the personal computer 311 obtains the configuration information from the mouse 821, the USB memory 822 and the printer 823 at step S310. The USB hub 810, however, does not terminate but relays a packet for obtaining the configuration information and accordingly does not send its own configuration information to the personal computer 311.

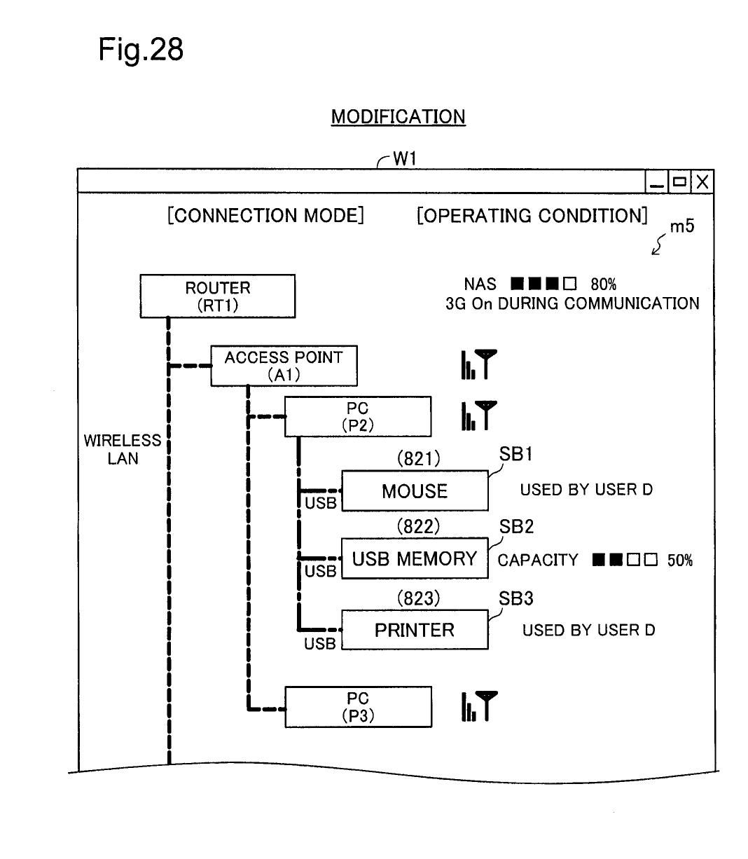

FIG. 28 illustrates one example of system configuration map displayed on the display of the management PC according to one modification. A system configuration map m5 shown in FIG. 28 is based on the connection configuration shown in FIG. 27. The system configuration map m5 differs from the system configuration map m1 of FIG. 10 in that symbols SB1, SB2 and SB3 respectively representing the mouse 821, the USB memory 822 and the printer 823 (FIG. 27) are located below the symbol of the personal computer 311 (P2), that the symbols SB1 to SB3 and the symbol of the personal computer 311 are connected by connection lines corresponding to the USB interface and that the operating conditions are displayed at the positions corresponding to the respective symbols SB1 to SB3, but otherwise has the similar structure to that of the system configuration map m1. For the convenience of explanation, only part of the system configuration map is shown in FIG. 28.

As described above, since the personal computer 311 is not notified of the configuration information of the USB hub 810 according to the connection configuration shown in FIG. 28, the management PC 303 cannot obtain the configuration information of the USB hub 810. The system configuration map m5 accordingly does not include a symbol representing the USB hub 810 as shown in FIG. 28.

F13. Modification 13

The failure alert is displayed to be superimposed on the operating condition and the software information for the preferential display according to the third embodiment, but the disclosure is not limited to this configuration. For example, in the ordinary state (without occurrence of any failure), the log information may be displayed on the right side of the information regarding the applied software (software name and version information) at the position corresponding to the symbol of a target device. In the state of occurrence of a failure (when the log information includes an error log), the error log may be arranged on the right side of the symbol of the target device (i.e., at the position closer to the symbol of the target device) to be displayed prior to the operating condition and the software information. For example, the failure alert may be displayed by a larger-size character string and in a more noticeable color (for example, failure alert shown in red, while operating condition and software information in black) than the operating information and the software information for the preferential display. According to another embodiment, the failure alert may be displayed to be superimposed on the operating condition and the software information like the third embodiment, but may disappear at preset intervals unlike the third embodiment. The intermittent disappearance of the failure alert allows the user to check the operating condition and the software information hidden by the failure alert. In this embodiment, the failure alert may be displayed preferentially by setting a longer time period to the appearance of the failure alert than the disappearance of the failure alert. According to another embodiment, the operating condition and the software information and the failure alert may alternately appear at preset intervals in the operating condition display area AR2 and the software information display area AR3. In this embodiment, the failure alert may be displayed preferentially by setting a longer time period to the display of the failure alert than the display of the operating condition and the software information.

The third embodiment displays the log information including an error log prior to the operating condition and the software information, but the log information without any error log may also be displayed preferentially.

The third embodiment displays the failure alert At in the occurrence of a failure, but part or all of the error log may be displayed in place of the failure alert At.

F14. Modification 14

At step S955 of the software update process of the above embodiment, the management PC 303 obtains the applied condition information with the newer version of the software from the software management server 700. Alternatively the management PC 303 may obtain the applied condition table TB1 with the newer version of the software. In this embodiment, the management PC 303 may analyze the applied condition table TB1 to identify the applied order of the software. The applied condition table TB1 itself sent from the software management server 700 to the management PC 303 in this embodiment corresponds to the applied order information in the claims. According to another embodiment, the software management server 700 may not store the applied condition table TB1, but only the management PC 303 stores the applied condition table TB1. In this embodiment, information regarding the applied condition may be sent at regular intervals or at any arbitrary timing from the software management server 700 to the management PC 303, and the management PC 303 may update the applied condition table TB1 based on the information received from the software management server 700.

F15. Modification 15

In the above embodiments, the configuration information obtained from each device as the first target device includes the software name and the version as the software identification information (steps S220, S305 and S405 of FIG. 7). The configuration information obtained from the first target device may, however, not include the software identification information. In this embodiment, for example, the management PC 303 as the management device may store the software identification information regarding the software installed in each device and update the software identification information (e.g., software name and version) of each device on every occasion of updating the software installed in each device.

The software to be applied to each device is identified by the software name and the version in the above embodiments, but the disclosure is not limited to this configuration. For example, when the version is included in part of the software name, the software to be applied may be identified only by the software name. When only one type of software is applied to each device, the software may be identified by the device name of the device and the version. In this embodiment, the configuration information may not include the software name. Information regarding the developer (provider) of the software, in addition to the software name and the version may be used as the information for identifying the software. According to another embodiment, an intrinsic ID may be allocated to each software applied to each device and may be used in place of the software name and the version. In this embodiment, each of the software management servers 700 may be designed to provide a functional block of correlating the ID to the information for identifying the software (software name and version) and may accordingly identify the software in response to an ID-specified request from the management PC 303 or 303a and supply the identified software to the management PC 303 or 303a.

F16. Modification 16

The management PC 303 or 303a obtains the configuration information of all the devices included in the system 500 in the above embodiments, but the disclosure is not limited to this configuration. One modified configuration may not obtain the configuration information of the router 100 but obtain the configuration information of all the other devices. Another modified configuration may obtain the configuration information of only the device with any lower-level device but not obtain the configuration information of the device without any lower-level device. Another modified configuration may obtain the configuration information of the device by a certain manufacturer but not obtain the configuration information of the devices by any other manufacturers. In general, at least either the router 100 or the other devices (first device and second device in the claims) may be adopted as the first target device or the second target device of the disclosure.

The same pieces of information are included in the configuration information with respect to all the devices in the above embodiments, but the disclosure is not limited to this configuration. Different pieces of information may be included in the configuration information with respect to at least part of the devices. For example, the configuration information of the router 100 may not include the software name or the version of the applied software, but the configuration information of all the other devices may include such information. In another example, the configuration information of the device using the bus interface for the connection interface with the higher-level device may not include the log information, but the configuration information of the device using the network interface for the connection interface with the higher-level device may include the log information.

F17. Modification 17

In the embodiments described above, part of the software configuration may be replaced by the hardware configuration. On the contrary, part of the hardware configuration may be replaced by the software configuration.

### G. Other Aspects

According to an aspect of an apparatus, the apparatus is configured to manage a system, wherein the system comprises a gateway device, a first device connected with the gateway device and a second device connected with the first device, wherein the second device has a greater number of devices intervening before the gateway device than the first device. The apparatus comprises: a configuration information acquirer configured to acquire configuration information and connected device identification information from a first target device that is at least one device of the gateway device, the first device and the second device, wherein (i) the configuration information includes information regarding a type of a connection interface included in the first target device, and device identification information used to identify the first target device, and (ii) the connected device identification information is used to identify a device connected with the first target device; a software acquirer configured to acquire software to be applied to at least the first target device from a server based on the obtained configuration information, wherein the server is connected with the apparatus via a network; a software application controller configured to apply the acquired software to the first target device; a display unit; and a map display controller configured to display a connection configuration map representing a connection configuration among the gateway device, the first device and the second device on the display unit, based on the obtained configuration information, wherein the connection configuration map represents that a symbol of the first device is arranged at a position closer to a symbol of the gateway device than a symbol of the second device, connection interfaces of the gateway device, the first device and the second device are shown in an identifiable manner, and the symbols of the gateway device, the first device and the second device are connected corresponding to an actual connections among the gateway device, the first device and the second device. The apparatus according to this aspect obtains the configuration information of the second device in addition to the configuration information of the first device and displays the connection configuration map, such that the device identification information of the respective devices (gateway device, first device and second device) is correlated to the corresponding symbols and such that the symbols of the respective devices are connected in the manner identifying the types of the connection interfaces, thus facilitating management of the plurality of devices connected by various interfaces. Additionally, the software acquirer collectively acquires the software to be applied to all the first target device, from the server. Compared with the configuration that each first target device individually acquires the software from the server, this configuration advantageously reduces the resources of the server and the resources required for communication between the respective devices and the server (e.g., network bandwidth). The software application controller applies the acquired software to the respective first target devices, so that the user is not required to check for the applied software, acquire (download) the corresponding software from the server and apply the software to the respective first target devices. This facilitates updating the software applied to the respective devices.

In the apparatus of the above aspect, the configuration information acquirer acquires the configuration information including information regarding a device type of the first target device, from the first target device, and the connection configuration map represents that device types of the gateway device, the first device and the second device are shown in an identifiable manner. In the apparatus of this aspect, displaying the connection configuration map informs the user of the device types of the gateway device, the first device and the second device.

In the apparatus of the above aspect, the first target device includes at least the first device and the second device, the software acquirer acquires first software to be applied to the first device, second software to be applied to the second device and applied order information representing an applied order of the first software and the second software, from the server, and the software application controller applies the first software to the first device and the second software to the second device in the applied order specified by the acquired applied order information. The apparatus of this aspect applies the first software to the first device and the second software to the second device in the applied order specified by the applied order information obtained from the server. This advantageously prevents application of the first software and the second software in a wrong order. Additionally, this does not require the user to manually apply the first software and the second software by taking into account the applied order, thus facilitating update of the software. The administrator for managing the supply of the first software and the second software may adjust the applied order information in the server, so as to control the applied order of the first software and the second software.

In the apparatus of the above aspect, the software acquirer acquires a plurality of software to be applied to an identical device of the first target device and applied order information representing an applied order of the plurality of software, from the server, and the software application controller applies the plurality of software to the identical device in the applied order specified by the obtained applied order information. The apparatus of this aspect applies the plurality of software to the identical device in the applied order specified by the applied order information acquired from the server. This advantageously prevents application of the plurality of software to the identical device in a wrong order. Additionally, this does not require the user to manually apply the plurality of software by taking into account the applied order, thus facilitating update of the software. The administrator for managing the supply of the plurality of software may adjust the applied order information in the server, so as to control the applied order of the plurality of software.

In the apparatus of the above aspect, the configuration information includes software identification information used to identify software to be applied to the first target device, and the connection configuration map represents the software identification information included in the acquired configuration information corresponding to a symbol of the first target device. The apparatus of this aspect enables the user (system administrator) to readily identify the software applied to the respective devices by simply observing the software identification information displayed in correlation to the symbols of the respective devices.

The configuration information acquirer may acquire the configuration information including the software identification information used to identify the applied software, from at least one device (first target device) among the respective devices. The software acquirer may thus collectively acquire the software to be applied to the first target device, from the server, based on the software identification information included in the acquired configuration information.

The apparatus of the above aspect further comprises a log information acquirer configured to acquire log information of a second target device that is at least one device of the gateway device, the first device and the second device, wherein the connection configuration map represents the acquired log information corresponding to a symbol of the second target device. The apparatus of this aspect enables the user (system administrator) to readily check the log (e.g., various event histories) in the second target device by simply observing the log information displayed in correlation to the symbols of the respective devices.

In the apparatus of the above aspect, the configuration information acquirer acquires the configuration information including information regarding a device type of the first target device, from the first target device, and the connection configuration map represents additional information corresponding to the symbol of the second target device, on the display unit, wherein the additional information comprises at least one information of the information regarding the device type, the information regarding the type of the connection interface, the device identification information and the software identification information, when the log information includes information indicating occurrence of a failure, the connection configuration map represents the log information or the information indicating occurrence of a failure, prior to the additional information. When a failure occurs in a device, the apparatus of this aspect displays the log information or the information regarding the occurrence of the failure prior to the additional information, thus preventing the user (system administrator) from overlooking the occurrence of the failure. The log information of the second target device has been obtained in advance in the apparatus, so that the user can immediately isolate a failure based on the log information, at the time of detecting the occurrence of the failure. Compared with the configuration of obtaining the log information from each device after detection of the occurrence of a failure, this advantageously shortens the time period before identifying the location and the cause of the failure.

In the apparatus of the above aspect, the configuration information includes software identification information used to identify software to be applied to the first target device, and the software identification information includes at least version information of the software. The apparatus of this aspect can unequivocally identify the software to be applied.

In the apparatus of the above aspect, a bus interface is used for a connection interface between the first device and the second device, the first device acquires the configuration information and the connected device identification information of the second device, from the second device, and the configuration information acquirer acquires the configuration information and the connected device identification information of the second device, from the first device. In the apparatus of this aspect, even when a bus interface is used for the connection interface between the first device and the second device and the direct transmission of data is unavailable between the apparatus and the second device, the apparatus can embodiment the configuration information of the second device. This enables the information of the second device to be displayed on the connection configuration map and updates the software applied to the second device.

According to an aspect of a method of managing a system, the aspect is directed to a method of managing a system by using an apparatus having a display unit, wherein the system comprises a gateway device, a first device connected with the gateway device and a second device connected with the first device, wherein the second device has a greater number of devices intervening before the gateway device than the first device. The method comprises (a) in the apparatus, acquiring configuration information and connected device identification information from a first target device that is at least one device of the gateway device, the first device and the second device, wherein (i) the configuration information includes information regarding a type of a connection interface included in the first target device, and device identification information used to identify the first target device, and (ii) the connected device identification information is used to identify a device connected with the first target device; (b) in the apparatus, acquiring software to be applied to at least the first target device from a server based on the obtained configuration information, wherein the server is connected with the apparatus via a network; (c) applying the acquired software to the first target device; (d) displaying a connection configuration map representing a connection configuration among the gateway device, the first device and the second device on the display unit, based on the acquired configuration information, wherein the connection configuration map represents that a symbol of the first device is arranged at a position closer to a symbol of the gateway device than a symbol of the second device, connection interfaces of the gateway device, the first device and the second device are shown in an identifiable manner, and the symbols of the gateway device, the first device and the second device are connected corresponding to an actual connections among the gateway device, the first device and the second device. The method according to this aspect obtains the configuration information of the second device in addition to the configuration information of the first device and displays the connection configuration map, such that the device identification information of the respective devices (gateway device, first device and second device) is correlated to the corresponding symbols and such that the symbols of the respective devices are connected in the manner identifying the types of the connection interfaces, thus facilitating management of the plurality of devices connected by various interfaces. Additionally, this method collectively acquires the software to be applied to all the first target device, from the server. Compared with the configuration that each first target device individually acquires the software from the server, this configuration advantageously reduces the resources of the server and the resources required for communication between the respective devices and the server (e.g., network bandwidth). This method also applies the acquired software to the respective first target devices, so that the user is not required to check for the applied software, acquire (download) the corresponding software from the server and apply the software to the respective first target devices. This facilitates updating the software applied to the respective devices.

According to an aspect of a computer program product, the computer program product comprises a non-transitory computer readable storage medium; and a computer program stored in the storage medium, wherein the computer program is executed by an apparatus having a display unit to manage a system, wherein the system comprises a gateway device, a first device connected with the gateway device and a second device connected with the first device, wherein the second device has a greater number of devices intervening before the gateway device than the first device, wherein the computer program comprises: (a) a program code for acquiring configuration information and connected device identification information from a first target device that is at least one device of the gateway device, the first device and the second device, wherein (i) the configuration information includes information regarding a type of a connection interface included in the first target device, and device identification information used to identify the first target device, and (ii) the connected device identification information is used to identify a device connected with the first target device; (b) a program code for acquiring software to be applied to at least the first target device from a server based on the obtained configuration information, wherein the server is connected with the apparatus via a network; (c) a program code for applying the acquired software to the first target device; (d) a program code for displaying a connection configuration map representing a connection configuration among the gateway device, the first device and the second device on the display unit, based on the acquired configuration information, wherein the connection configuration map represents that a symbol of the first device is arranged at a position closer to a symbol of the gateway device than a symbol of the second device, connection interfaces of the gateway device, the first device and the second device are shown in an identifiable manner, and the symbols of the gateway device, the first device and the second device are connected corresponding to an actual connections among the gateway device, the first device and the second device. The computer program product according to this aspect obtains the configuration information of the second device in addition to the configuration information of the first device and displays the connection configuration map, such that the device identification information of the respective devices (gateway device, first device and second device) is correlated to the corresponding symbols and such that the symbols of the respective devices are connected in the manner identifying the types of the connection interfaces, thus facilitating management of the plurality of devices connected by various interfaces. Additionally, this computer program product collectively acquires the software to be applied to all the first target device, from the server. Compared with the configuration that each first target device individually acquires the software from the server, this configuration advantageously reduces the resources of the server and the resources required for communication between the respective devices and the server (e.g., network bandwidth). This computer program product also applies the acquired software to the respective first target devices, so that the user is not required to check for the applied software, acquire (download) the corresponding software from the server and apply the software to the respective first target devices. This facilitates updating the software applied to the respective devices.

The above computer program product may implemented by a computer readable medium recording the above computer program.

The recording medium of this embodiment enables the computer to read the program and implement the respective functions.

The invention may be implemented by diversity of other applications, for example, a device management system, a method of operating the device management system, a computer program to enable the functions of the device management system and a non-transitory computer readable storage medium, in which the computer program is recorded. The disclosure may also be implemented by a server connected with a apparatus via a network. Some aspects of this application are described below.

According to one aspect of a server, the server is connected via a network with an apparatus configured to manage a system comprising a gateway device, a first device connected with the gateway device and a second device connected with the first device, wherein the second device has a greater number of devices intervening before the gateway device than the first device. The server comprises: first software executed by the first device; second software executed by the second device; a table configured to store software identification information used to identify each of the first software and the second software, in correlation to software identification information of software to be applied prior to application of the first software or the second software; and a transmitter configured to send the first software and the second software to the apparatus and to send applied order information regarding an applied order of the first software and the second software based on the table, to the apparatus. The server according to this aspect can adjust the “software identification information of the software to be applied prior to application of the first software or the second software” in the table, so as to control the applied order of the first software and the second software. The server sends the applied order information with the first software and the second software to the apparatus and thus notifies the apparatus of the applied order (i.e., gives the apparatus an instruction on the applied order) of the first software and the second software based on the applied order information.

According to another aspect of a server, the server is connected via a network with an apparatus configured to manage a system comprising a gateway device, a first device connected with the gateway device and a second device connected with the first device, wherein the second device has a greater number of devices intervening before the gateway device than the first device. The server comprises: a plurality of software to be executed by one of the gateway device, the first device and the second device; a table configured to store software identification information used to identify each of the plurality of software, in correlation to software identification information of software to be applied prior application of one of the plurality of software; and a transmitter configured to send the plurality of software to the apparatus and to send applied order information regarding an applied order of the plurality of software based on the table, to the apparatus. The server according to this aspect can adjust the “software identification information of the software to be applied prior to application of one of the plurality of software” in the table, so as to control the applied order of the plurality of software. The server sends the applied order information with the plurality of software to the apparatus and thus notifies the apparatus of the applied order (i.e., gives the apparatus an instruction on the applied order) of the plurality of software based on the applied order information.

What is claimed is:

1. An apparatus configured to manage a system including a gateway device, a first device connected with the gateway device and a second device that is connected with the first device and has a greater number of devices intervening before the gateway device than the first device, the apparatus comprising:
a configuration information acquirer that acquires configuration information and connected device identification information from a first target device that is at least one of the gateway device, the first device and the second device, wherein the configuration information includes information indicating a type of a connection interface included in the first target device and device identification information identifying the first target device, and the connected device identification information identifies a device connected to the first target device;
a software acquirer that acquires software to be applied to at least the first target device from a server based on the obtained configuration information, wherein the server is connected with the apparatus via a network; and
a software application controller that applies the acquired software to the first target device.

2. The apparatus according to claim 1, further comprising:
a display; and
a map display controller that controls the display to display a connection configuration map indicating a connection configuration among the gateway device, the first device and the second device based on the obtained configuration information.

3. The apparatus according to claim 2, wherein
the connection configuration map includes a symbol representing the first device arranged at a position closer to a symbol representing the gateway device than a symbol representing the second device.

4. The apparatus according to claim 2, wherein
the connection configuration map includes information identifying connection interfaces of the gateway device, the first device and the second device.

5. The apparatus according to claim 3, wherein
the connection configuration map includes connections between the symbol representing the gateway device, the symbol representing the first device and the symbol representing the second device that indicate actual connections between the gateway device, the first device and the second device.

6. The apparatus according to claim 2, wherein
the configuration information acquirer acquires the configuration information including information regarding a device type of the first target device, from the first target device, and
the connection configuration map includes information indicating device types of the gateway device, the first device and the second device.

7. The apparatus according to claim 1, wherein
the first target device includes at least the first device and the second device,
the software acquirer acquires, from the server, first software to be applied to the first device, second software to be applied to the second device and applied order information representing an applied order of the first software and the second software, and
the software application controller applies the first software to the first device and the second software to the second device in the applied order specified by the acquired applied order information.

8. The apparatus according to claim 1, wherein
the software acquirer acquires a plurality of software to be applied to a device that is identical to the first target device and applied order information representing an applied order of the plurality of software, from the server, and
the software application controller applies the plurality of software to the identical device in the applied order specified by the obtained applied order information.

9. The apparatus according to claim 2, wherein
the configuration information includes software identification information identifying software to be applied to the first target device, and
the connection configuration map includes information related to the software identification information at a position corresponding to a symbol of the first target device.

10. The apparatus according to claim 2, further comprising:
a log information acquirer that acquires log information of a second target device that is at least one of the gateway device, the first device and the second device, wherein
the connection configuration map includes information related to the acquired log information at a position corresponding to a symbol of the second target device.

11. The apparatus according to claim 10, wherein
the configuration information acquirer acquires, from the second target device, the configuration information including information regarding a device type of the second target device, and
the connection configuration map includes information related to at least one of the device type, the information regarding the type of the connection interface, the device identification information and the software identification information at a position corresponding to a symbol of the second target device,
when the log information includes information indicating occurrence of a failure, the connection configuration map represents the log information or the information indicating occurrence of a failure, prior to the additional information.

12. The apparatus according to claim 1, wherein
the configuration information includes software identification information identifying software to be applied to the first target device, and
the software identification information includes at least version information of the software.

13. The apparatus according to claim 1, wherein
a connection interface between the first device and the second device is a bus,
the first device acquires, from the second device, the configuration information and the connected device identification information of the second device, and
the configuration information acquirer acquires, from the first device, the configuration information and the connected device identification information of the second device.

14. A method of managing a system by using an apparatus having a display, wherein the system comprises a gateway device, a first device connected with the gateway device and a second device that is connected with the first device and has a greater number of devices intervening before the gateway device than the first device, the method comprising:
acquiring, by the apparatus, configuration information and connected device identification information from a first target device that is at least one of the gateway device, the first device and the second device, wherein the configuration information includes information indicating a type of a connection interface included in the first target device and device identification information identifying the first target device, and the connected device identification information identifies a device connected to the first target device;
acquiring, by the apparatus from a server, software to be applied to at least the first target device based on the obtained configuration information, wherein the server is connected with the apparatus via a network; and
applying the acquired software to the first target device.

15. The method according to claim 14, further comprising:
displaying, by the display, a connection configuration map that includes information indicating a connection configuration among the gateway device, the first device and the second device based on the acquired configuration information, wherein
the connection configuration map includes
a symbol representing the first device arranged at a position closer to a symbol representing the gateway device than a symbol representing the second device,
information identifying connection interfaces of the gateway device, the first device and the second device, and
connections between the symbol representing the gateway device, the symbol representing the first device and the symbol representing the second device that indicate actual connections between the gateway device, the first device and the second device.

16. The method according to claim 15, wherein
the acquiring configuration information includes obtaining, by the apparatus from the first target device, the configuration information including information indicating a device type of the first target device, and
the connection configuration map includes information indicating device types of the gateway device, the first device and the second device.

17. A non-transitory computer-readable medium including computer program instructions, which when executed by an apparatus, causes the apparatus to perform a method of managing a system comprising a gateway device, a first device connected with the gateway device and a second device that is connected with the first device and has a greater number of devices intervening before the gateway device than the first device, the method of managing a system comprising:
acquiring configuration information and connected device identification information from a first target device that is at least one of the gateway device, the first device and the second device, wherein the configuration information includes information indicating a type of a connection interface included in the first target device and device identification information identifying the first target device, and the connected device identification information identifies a device connected with the first target device;
acquiring software to be applied to at least the first target device from a server based on the obtained configuration information, wherein the server is connected with the apparatus via a network; and
applying the acquired software to the first target device.

18. The non-transitory computer-readable medium according to claim 17, wherein the method of managing further comprises:
displaying a connection configuration map that includes information indicating a connection configuration among the gateway device, the first device and the second device based on the acquired configuration information, wherein
the connection configuration map includes
a symbol representing the first device arranged at a position closer to a symbol representing the gateway device than a symbol representing the second device,
information identifying connection interfaces of the gateway device, the first device and the second device, and
connections between the symbol representing the gateway device, the symbol representing the first device and the symbol representing the second device that indicate actual connections between the gateway device, the first device and the second device.

19. The non-transitory computer-readable medium according to claim 18, wherein
the acquiring configuration information includes obtaining, from the first target device, the configuration information including information indicating a device type of the first target device, and
the connection configuration map includes information indicating device types of the gateway device, the first device and the second device.
